(19) United States
(12) Patent Application Publication
(10) Pub. No.: US 2025/0363560 A1
(43) Pub. Date: Nov. 27, 2025

(54) SYSTEMS AND METHODS FOR SIMULATING FUTURE ASSET PERFORMANCE BASED ON CONSUMABLE MEDIA CONTENT

(71) Applicant: Wells Fargo Bank, N.A., San Francisco, CA (US)

(72) Inventors: Maximilian Fuchs, Charlotte, NC (US); Scott David Hutula, Concord, NC (US); Deepak Elias, Wilton, CT (US); Steven A. Jolley, Chester, SC (US)

(21) Appl. No.: 18/671,523

(22) Filed: May 22, 2024

(51) Int. Cl. G06Q 40/06

(52) U.S. Cl. CPC G06Q 40/06

(57) ABSTRACT

Systems, apparatuses, methods, and computer program products are disclosed for simulating future asset performance based on consumable media content. An example method includes monitoring a user device for receipt of a data stream comprising media content. The example method further includes receiving a simulation request requesting a prediction model for an asset of a user portfolio based on the media content. The example method further includes generating a prediction model output indicating future performance of the asset of the user portfolio based on the media content and historical data. The example method further includes generating a natural language report representative of the future performance of the asset of the user portfolio. The example method may further include transmitting the natural language report to the user device.

### BACKGROUND

As more of the media industry adopts digital technologies, more individuals are receiving their news through digital distribution channels such as the Internet. Such digital distribution of news content has provided users with more news sources and has made these news sources more easily accessible. For example, news programs and articles can be streamed or downloaded to smart devices almost anywhere an Internet connection is available, enabling users to learn about current events as they unfold.

### BRIEF SUMMARY

With the rise of the Internet and the increase in the availability of smart devices over recent years, many individuals utilize a Personal Internet of Things (PIoT) to access digitally distributed content. For example, an individual may stream shows and movies on their smart television and interact with friends and family via social media applications on their smartphone. In addition, individuals may utilize their smart devices to manage their personal and/or financial life. For example, an individual may direct their financial investments (e.g., stocks, bonds, mutual funds, 401k, etc.), pay bills, and monitor their bank accounts (e.g., savings, checking, etc.) from a personal computer or other device. Some individuals may leverage the increase in communication channels to regularly update their financial plans and strategies with their financial advisors, such as through application, email, text, or phone calls. Other individuals may manage their financial investments directly via websites or applications without the guidance of a financial advisor or firm.

While users can more easily access an ever-growing amount of digital content for news, entertainment, and purposes of staying connected, traditionally, it has been difficult for users to identify and interpret information from media content that is most relevant to their personal and/or financial lives. For example, users may be bombarded with news articles and other types of media related to current events on a daily basis without a means to filter through all of the information and understand how these events will affect their personal lives (e.g., vacations, retirement, etc.), careers, and/or financial investments. In addition, news articles and other media (e.g., social media) may emphasize particular elements that contribute to a compelling story while downplaying or not mentioning other elements that may directly impact their audience (e.g., via local financial markets, impacts to supply chains, etc.). Accordingly, it has been difficult for users to fully comprehend how, or if, they should adjust their financial plans based on world events identified in particular news stories. Traditional media systems (e.g., news applications, websites, etc.) may link (e.g., hyperlinks within an article) to other articles discussing the impact of current events on the wider market (e.g., a general impact on the stock market); however, these conventional systems have traditionally been unable to provide a detailed analysis of the impact of each current event on a particular viewer's financial investments or personal life. For example, there has traditionally been no way to determine correlation or causation between a current event and the future performance of a personalized investment portfolio (e.g., because each user may hold different types and/or quantities of investments, each user may react differently to changing risks brought on by the current events, similar investments may be affected differently by the same events, etc.).

In addition, even with the help of a human financial advisor, there is typically no way to fully comprehend the impact of each current event for each individual investor because human financial advisors are also not able to ingest every news story, or even a statistically significant sample size, and individually analyze each of their clients' investment portfolios in light of the pertinent facts and historical trends relevant to each event and/or each investment. Even if were somehow possible to do this manually, it is certainly not possible to manually analyze and offer advice in real-time, which is a practical necessity for a user to gain the benefit of that advice at the time that they are reading the news story. Traditional analytics systems and techniques employed by individuals or financial institutions (e.g., banks, financial advisors, etc.) have historically lacked a practical way to objectively track and connect financial market performance with current events over extended periods of time for individual investments and/or investment portfolios. When traditional analyses have been attempted (e.g., manually by a human being) on an event-by-event basis (e.g., comparing the financial market impacts of the COVID-19 pandemic of 2020 and the influenza pandemic of 1918), other factors (e.g., availability of the Internet, remote work, international politics at the time, etc.) may complicate the comparison and, thus, may be overlooked (e.g., based on subjective human perceptions and/or biases) and/or purposely omitted (e.g., to simplify the analysis, save time, and/or present particular narratives) which compromises the accuracy of any resulting prediction models (e.g., assembled using subjective human perceptions). As a result, traditional analytics systems and techniques employed by individuals or financial institutions have historically had to rely on overly simplified and/or biased prediction models for forecasting the future impact of current events on not only the financial markets as a whole but on individual portfolios. In addition, traditional prediction models can be difficult to understand and apply in a meaningful way for individual investors because they are often presented as statistical models and/or lengthy analytical documents that do not easily translate to a clear financial strategy (e.g., a precise individualized financial plan for a particular investment portfolio).

In contrast to these traditional analytics systems and/or techniques for analyzing current events and/or other market factors to produce traditional prediction models, example embodiments described herein leverage various data sources (e.g., financial or media databases, streaming media, user surveys, etc.) and Artificial Intelligence (AI) systems to generate natural language reports that detail predictions for individual investments and investment portfolios. Example embodiments described herein may comprise a predictive advisement system equipped with a combination of AI algorithms such as pattern recognition algorithms, artificial neural networks, Generative AI (GenAI), and/or the like as described herein to analyze media content (e.g., news articles, videos, etc.), historical data (e.g., historical events, stock market data, etc.), and user data (e.g., banking information, financial investments, personal risk assessments, etc.) in order to detail (e.g., in a natural language report) financial advice pertinent to a particular user. Some example embodiments described herein may comprise a software plugin (and/or the like as described herein) installed on one or more user devices (e.g., mobile device, televisions, etc.) of a user's Personal Internet of Things (PIoT) that may be used to identify media content for further analysis. For example, the user may interact with the software plugin, across their PIoT, while ingesting news articles, videos, podcasts, and/or any other digital media content as described herein in order to request more information and receive personalized reports.

Accordingly, the present disclosure sets forth systems, methods, and apparatuses that provide improved systems and techniques for simulating future asset performance based on consumable media content. There are many advantages of these, and other, embodiments described herein over the conventional systems described above.

One advantage is that example embodiments provide an improvement to the functionality available to a PIOT and/or individual user devices. Example embodiments may accomplish this by incorporating a software plugin (or the like as described herein) across one or more user devices to monitor open ports (e.g., network ports, software ports, etc.) for media content ingested by a user. In addition, the software plugin may allow a user to identify media content and/or request a personalized report on one device while receiving the report regarding the media content on another device of their PIoT. Accordingly, the software plugin as described herein may integrate various computing functionalities (e.g., internet searching, video/audio playback, data analysis, etc.) specific to individual devices of a PIoT and integrate these various computing functionalities and devices into a more cohesive PIoT system to streamline device-to-device interactions, user-to-device interactions, and/or the presentation of media content (and/or additional information as described herein, such as natural language reports) to a user. Such example embodiments provide improvements to the functionality available to a PIoT and/or individual user devices by increasing code readability and usability (or reusability) between individual devices (e.g., of a PIoT, media content servers, etc.), while reducing the complexity (or increasing manageability) of user interactions (e.g., by using a single software plugin based user interface instead of individual device specific user interfaces for each device).

Another advantage is that example embodiments provide a computational ability to predict the interplay and/or influence between two or more current events when such influence may otherwise be undetectable for a human user and/or beyond the original scope of identified media content. Generating a quantitative prediction (e.g., based on a prediction model) of other factors that may influence a user's investment portfolio using current media content and historical data (e.g., trends, patterns, historical event outcomes, etc.) may enable more tailored (or personalized) predictions for a user to be taken while avoiding undue burdens on processing and network resources due to suboptimal media content information and/or user input prompts.

Yet another advantage is that example embodiments provide an improvement over traditional financial analytics systems by presenting (or rendering) the results of a quantitative prediction (e.g., based on a prediction model) through a natural language report that is more easily ingested and understood by an end-user. For example, in contrast to traditional financial forecast models that provide statistical graphs and tables that may be difficult to interpret, example embodiments may convert (or translate) quantitative predictions (e.g., probabilities, forecast errors, statistical charts or tables, etc.) into a natural language report (e.g., text, audio, and/or video provided in a conversational manner) that is easy to understand and that provides clear recommendations to act upon (e.g., by buying/selling stocks, holding more cash, etc.).

In addition, because the natural language reports may be provided by AI systems (e.g., a Large Language Model (LLM), etc.), such reports may provide a more objective interpretation of the quantitative data and/or qualitative data pertinent to the user. For example, an analysis (or interpretation) provided (e.g., manually) by a human may be more subjective (or biased) based on the individual's past personal experiences. As a result, subjective human analysis may over (or under) emphasize certain factors of the quantitative data and/or qualitative data based solely on personal bias or perceptions and not on an objective understanding (e.g., of investments, current events, historical outcomes, emerging patterns from different datasets, etc.).

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for incorporating a predictive advisement system.

FIG. 2 illustrates a schematic block diagram of example circuitry embodying a predictive advisement system device that may perform various operations in accordance with some example embodiments described herein.

FIG. 3 illustrates a schematic block diagram of example circuitry embodying a user device and/or media content server that may perform various operations in accordance with some example embodiments described herein.

FIG. 4 illustrates an example flowchart for simulating future asset performance, in accordance with some example embodiments described herein.

FIG. 5A illustrates an example flowchart for monitoring a user device for media content, in accordance with some example embodiments described herein.

FIG. 5B illustrates an example flowchart for requesting a simulation of future asset performance, in accordance with some example embodiments described herein.

FIG. 5C illustrates an example flowchart for triggering a simulation of future asset performance, in accordance with some example embodiments described herein.

FIG. 5D illustrates an example flowchart for generating a prediction model, in accordance with some example embodiments described herein.

FIG. 5E illustrates an example flowchart for generating a prediction model, in accordance with some example embodiments described herein.

FIG. 5F illustrates an example flowchart for generating a prediction model output, in accordance with some example embodiments described herein.

FIG. 5G illustrates an example flowchart for generating a natural language report, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “Artificial Intelligence (AI) system” or “AI system” refers to any computing device, server, and/or computing network comprising one or more of a Generative Artificial Intelligence (GenAI) model, Large Language Model (LLM), artificial neural network, Machine Learning (ML) model, and/or any other AI algorithms, models and/or applications as described herein.

The term “media content” refers to any digitally distributed data associated with a current event. Example media content may include, without limitation, one or more of a news article, video data object (e.g., streaming video, video file, etc.), audio data object (e.g., streaming podcast, audio file, etc.), transcript of a video and/or audio data object, webpage, social media posting (e.g., by an official corporate account, owner or chief officer of an organization, political figures, etc.), and/or the like as described herein.

The term “quantitative prediction” refers to any numerical data (e.g., mathematical data, statistical data, etc.) representative of the future performance of one or more of an asset, an investment, and/or a financial portfolio. Example quantitative predictions may include, without limitation, one or more of a numerical value, vector, probability, correlation coefficient, equation or formula, revenue run rate, growth rate, time series data, seasonal forecast, linear regression, Naïve forecast and/or the like as described herein. In some embodiments, a prediction model may generate a quantitative prediction based on numerical data obtained (e.g., inferred, mined, and/or scraped) from one or more of media content, historical data, and/or any other documentation as described herein.

The term “qualitative prediction” refers to any natural language data representative of the future performance of one or more of an asset, an investment, and/or a financial portfolio. Example qualitative predictions may include, without limitation, one or more of a natural language report, a description of one or more quantitative predictions, and/or the like as described herein. In some embodiments, a natural language model, LLM, and/or the like as described herein may generate a qualitative prediction based on one or more quantitative predictions and any associated media content, historical data, and/or any other documentation as described herein. In some such embodiments, the natural language model, LLM, and/or the like as described herein may be trained based on transcripts of expert financial and/or political projections, financial advisor reports (e.g., reports or conversations provided to clients), company officer (e.g., Chief Executive Officer (CEO), Chief Financial Officer (CFO), and/or any other company employee) opinions (e.g., official reports, social media posts, etc.), and/or any other qualitative forecasts described herein. In some embodiments, a qualitative prediction may comprise a natural language report representative of an interpretation of quantitative prediction based on expert financial and/or political projections, context of any documentation associated with the quantitative prediction, and/or the like as described herein.

The term “asset disclosure” refers to any information associated with an asset and/or investment. Example asset disclosures may include, without limitation, one or more of a financial disclosure document, prospectus, public records (e.g., police reports, tax records, etc.), stock market charts, home price trends, and/or any other information associated with an asset and/or investment as described herein.

### System Architecture

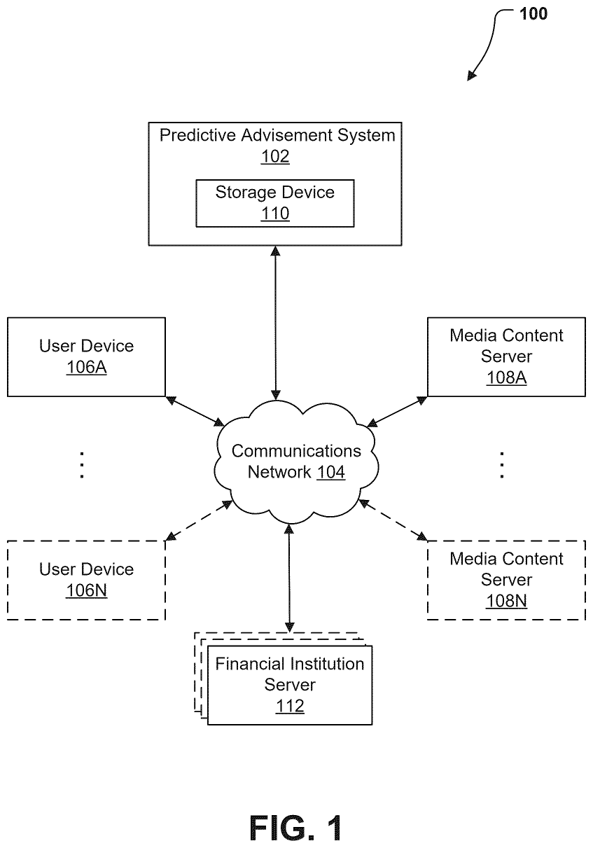

Example embodiments described herein may be implemented using any of a variety of computing devices or servers. To this end, FIG. 1 illustrates an example environment 100 within which various embodiments may operate. As illustrated, a predictive advisement system 102 may receive and/or transmit information via communications network 104 (e.g., the Internet, and/or the like) with any number of other devices, such as one or more of a financial institution server 112, user devices 106A-106N, and/or media content servers 108A-108N.

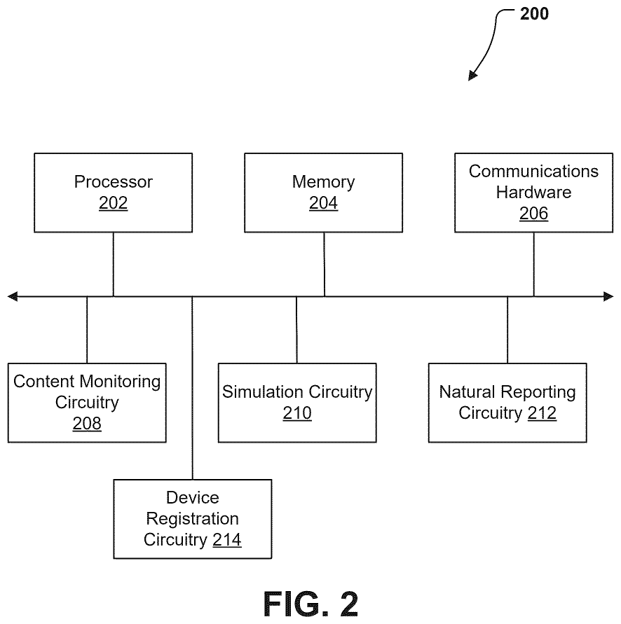

The predictive advisement system 102 may be implemented as one or more computing devices and/or servers, which may be composed of a series of components. Particular components of the predictive advisement system 102 are described in greater detail below with reference to apparatus 200 in connection with FIG. 2.

In some embodiments, the predictive advisement system 102 further includes a storage device 110 that comprises a distinct component from other components of the predictive advisement system 102. Storage device 110 may be embodied as one or more direct-attached storage (DAS) devices (such as hard drives, solid-state drives, optical disc drives, and/or the like) or may alternatively comprise one or more Network Attached Storage (NAS) devices independently connected to a communications network (e.g., communications network 104). Storage device 110 may host any executable software instructions to operate the predictive advisement system 102. Storage device 110 may host any executable software instructions for installing a software plugin, add-in, add-on, application, and/or the like as described herein, on a user device (e.g., any of user devices 106A-106N, associated with an individual user, investor, and/or financial advisor). Storage device 110 may host any executable software instructions for communicatively coupling the predictive advisement system 102 via communications network 104 (e.g., the Internet, and/or the like) with any number of other devices, such as one or more of a financial institution server 112 (e.g., comprising one or more servers associated with one or more of a bank, investment advisor/firm, and/or the like), user devices 106A-106N and/or media content servers 108A-108N, using an Application Programming Interface (API) and/or any other software interface as described herein.

Storage device 110 may store information relied upon during operation of the predictive advisement system 102, such as various user profile information (e.g., a user's risk profile, contact information, user survey data, user device identifiers, bank account data, investment portfolio data, real estate holding addresses, etc.), media content data (e.g., transcripts, keywords, tables, charts, etc.), financial disclosure documents or data (e.g., asset class, risk ratings, historical performance, fees, financial prospectuses, etc.), prediction models, prediction model output data, previously generated reports, and/or any other data described herein that is used or generated during operation of the predictive advisement system 102. In addition, storage device 110 may store control signals, device characteristics (e.g., Operating System (OS), Internet Protocol (IP) Address, and/or the like), and/or access credentials (e.g., security certificates, passwords, handshake protocols, and/or the like) for enabling interaction between the predictive advisement system 102 and one or more of a financial institution server 112, user devices 106A-106N and/or media content servers 108A-108N.

One or more of the financial institution server 112, user devices 106A-106N, and/or the one or more media content servers 108A-108N may be embodied by any computing devices known in the art. The financial institution server 112, the user devices 106A-106N, and/or the media content servers 108A-108N need not themselves be independent devices but may be peripheral devices communicatively coupled to other computing devices.

Although FIG. 1 illustrates an environment and implementation in which the predictive advisement system 102 interacts indirectly with a user via one or more of user devices 106A-106N, financial institution server 112, and/or media content servers 108A-108N, in some embodiments users may directly interact with the predictive advisement system 102 (e.g., via a user interface and/or communications hardware of the predictive advisement system 102). In some embodiments, the predictive advisement system 102 may comprise one or more AI systems (e.g., GenAI, LLM, machine learning models, artificial neural networks, etc.) and/or may leverage externally hosted AI systems (e.g., cloud services, web services, and/or the like, via communications network 104) to perform one or more AI operations as described herein. Whether by way of direct interaction or indirect interaction via another device, a user may communicate with, operate, control, modify, or otherwise interact with the predictive advisement system 102 to perform the various functions and achieve the various benefits described herein.

### Example Implementing Apparatuses

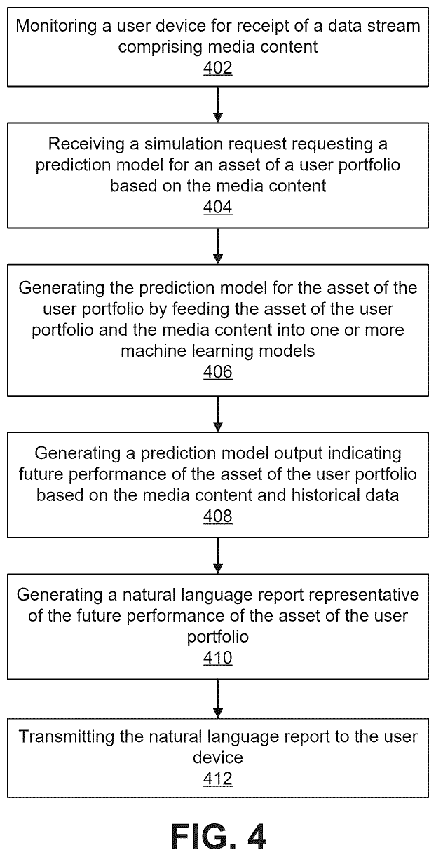

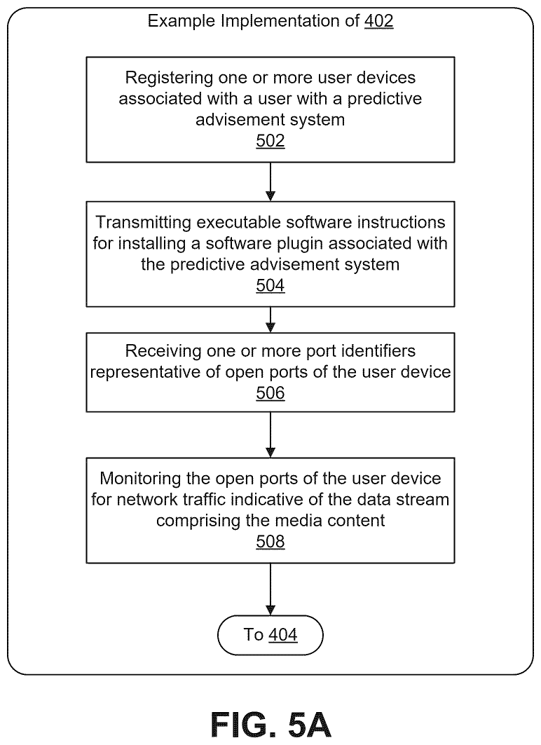

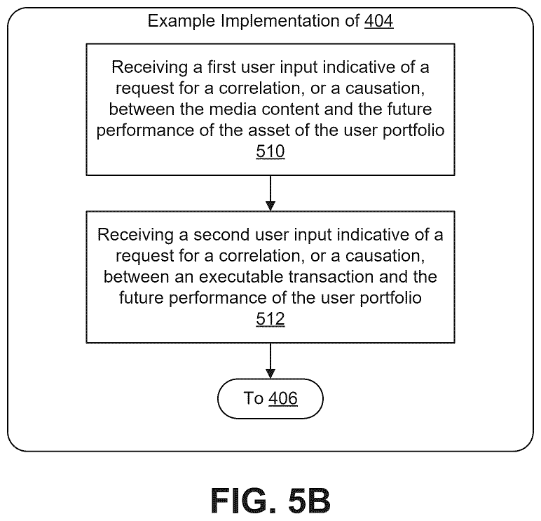

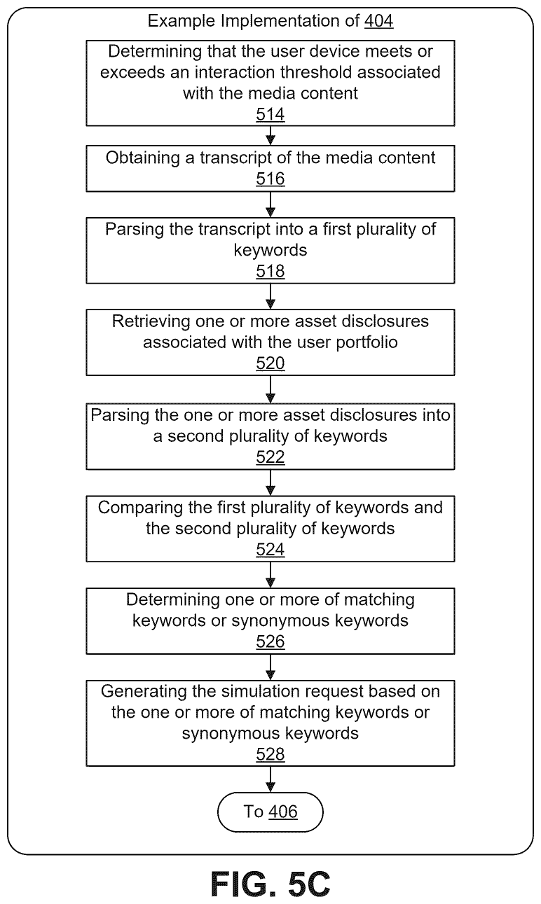

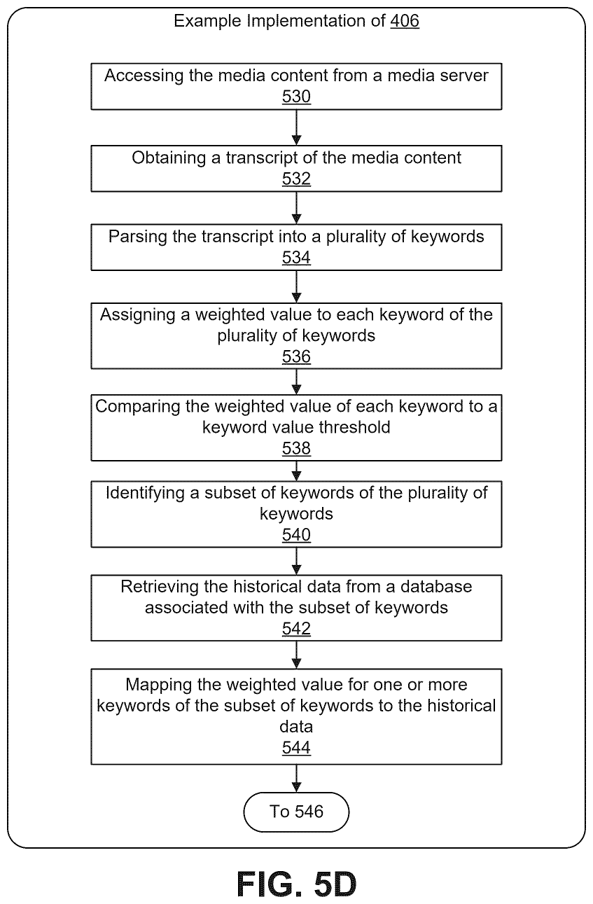

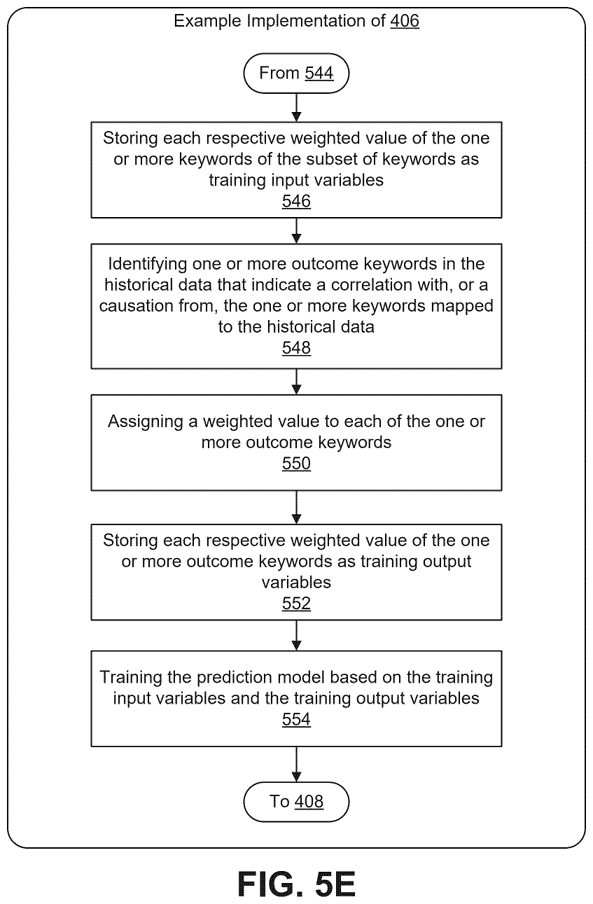

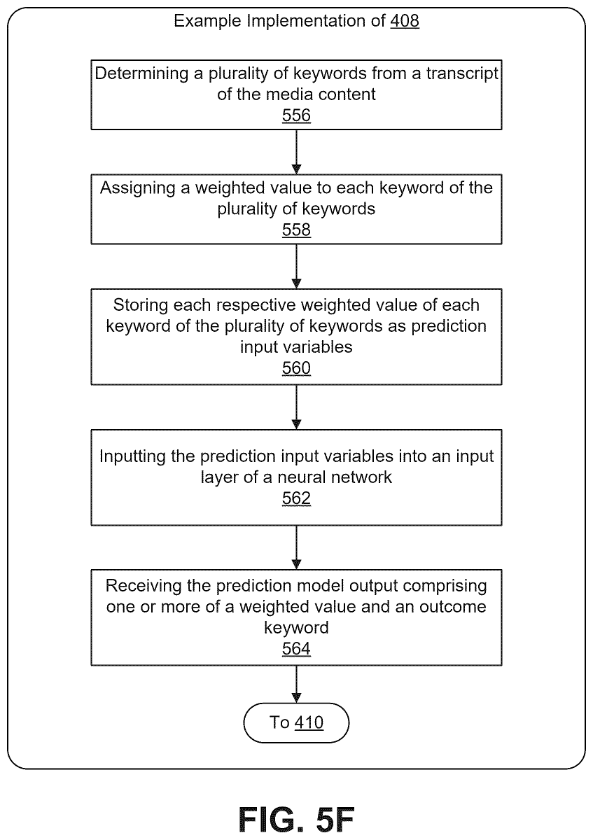

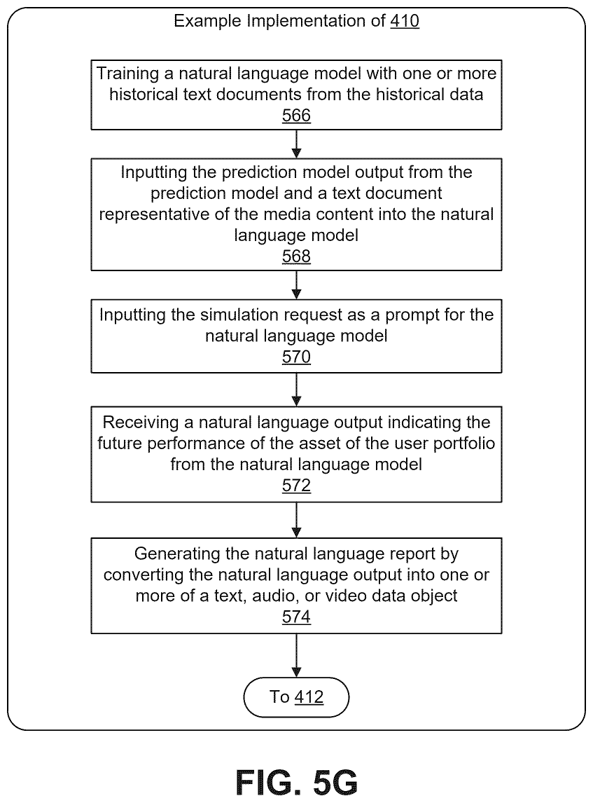

The predictive advisement system 102 (described previously with reference to FIG. 1) may be embodied by one or more computing devices and/or servers, shown as apparatus 200 in FIG. 2. The apparatus 200 may be configured to execute various operations described above in connection with FIG. 1 and/or below in connection with FIGS. 4 and 5A-5G. As illustrated in FIG. 2, the apparatus 200 may include processor 202, memory 204, communications hardware 206, content monitoring circuitry 208, simulation circuitry 210, natural language circuitry 212, and device registration circuitry 214, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represents an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processor 202 for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include one or more of a keyboard, mouse, touch screen, touch area, soft key, microphones, speaker, light (e.g., light emitting diode (LED), etc.), and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises content monitoring circuitry 208 that detects media content, and/or financial assets, of interest to a user (e.g., an article or video of interest, etc.). In some embodiments, the content monitoring circuitry 208 may be any means such as a device or circuitry embodied in either hardware (e.g., application specific interface circuit (ASIC) and/or the like as described herein) or a combination of hardware and software (e.g., algorithms and/or the like as described herein) that is configured to monitor a user device (e.g., any of user devices 106A-106N, such as via a software plugin) for media content, receive a simulation request (e.g., from a user via communications hardware 206), access media content (e.g., from any of media content servers 208A-208N via communications hardware 206), and/or the like as described below. The content monitoring circuitry 208 may utilize processor 202, memory 204, and/or any other hardware component included in the apparatus 200 to perform these operations which are described in greater detail below in connection with FIGS. 4 and 5A-5C. The content monitoring circuitry 208 may further utilize communications hardware 206 to gather data from a variety of sources (e.g., storage device 110, financial institution server 112, user devices 106A-106N, and/or media content servers 208A-208N as shown in FIG. 1), and/or exchange data with a user (e.g., an individual investor and/or financial advisor).

For example, the content monitoring circuitry 208 may utilize communications hardware 206 to receive one or more data objects (e.g., data packets, user inputs signals, simulation requests, etc.) from a software plugin installed on a user device (e.g., any of user devices 106A-106N). In such embodiments, the one or more data objects may indicate media content that has been rendered (e.g., via a display, speaker, etc.) on the user device. For example, a user may provide (e.g., manually via a user interface, the software plugin, and/or the like) a user input comprising a simulation request indicating media content (e.g., an article or video) for further analysis by the predictive advisement system 102. In some such embodiments, the user may also indicate one or more assets (e.g., available for purchase, held in the user's investment portfolio, etc.) that should be analyzed in light of the indicated media content. In some embodiments, the one or more data objects may comprise one or more media content and/or user metrics associated with the reported media content. For example, the one or more data objects may comprise timestamp data indicating how long a user watched a video or listened to media content (e.g., newscast, podcast, radio show, etc.). Additionally or alternatively, the one or more data objects may comprise how many times a user accessed (e.g., by clicking on a Uniform Resource Locator (URL), etc.) a particular piece of media content. For example, the one or more data objects may indicate that a user device rendered the same (or similar) piece of media content 3 times (or any other number) in the past hour (or any other timeframe). Two or more pieces of media content may be determined to be similar if they are determined to share the same or synonymous keywords and the same topic or subject (e.g., person, place, timeframe, and/or event). The content monitoring circuitry 208 may utilize natural language circuitry 212 to determine if two or more pieces of media content (e.g., media content of interest indicated by a user, historical media content or other data, etc.) are similar using keyword clustering, K-Means clustering with text documents, word embedding or vectorization techniques (e.g., Word2vec, Global Vectors (GloVe), etc.), and/or any other semantic meaning or context grouping techniques as described herein. The content monitoring circuitry 208 may generate and/or store a history of a user's media content consumption. This history may be made available to the user and/or their financial advisor. This history may be utilized to locate and/or search for additional or similar media content (e.g., for use as a prediction or training input into one or more AI systems).

In some embodiments, the content monitoring circuitry 208 may determine, based on comparing one or more metrics from the one or more data objects to an interaction threshold, that a user may be interested in receiving more information about a piece of media content and, in response, the content monitoring circuitry 208 may utilize communications hardware 206 to transmit a notification to the user device asking the user if they would like additional information. For example, the content monitoring circuitry 208 may determine that a user may be interested in additional information if they view an article or video for more than 10 minutes (or any other threshold number) and/or if they access the same (or similar) media content more than 5 times (or any other threshold number). In some embodiments, when the content monitoring circuitry 208 determines that a user may be interested in additional information, the content monitoring circuitry 208 may utilize processor 202, memory 204, and/or simulation circuitry 210 to internally (or automatically) generate a simulation request for the media content and/or one or more assets in the user's investment portfolio. The content monitoring circuitry 208 may utilize communications hardware 206 to transmit the internally generated simulation request (or simulation suggestion) to the user in order to receive a user input approving the simulation request. In some embodiments, the apparatus 200 may automatically act upon the internally generated simulation request (e.g., in accordance with the operations of FIGS. 4 and 5A-5G described below) and transmit the resulting natural language report to the user.

Additionally or alternatively, the one or more data objects may comprise location data indicating an origin or access location for the media content. For example, the one or more data objects may comprise an Internet Protocol (IP) address, URL, server identifier, and/or any other identifier for indicating a media content server (e.g., any of media content servers 208A-208N), or the like, from which the media content may be accessed (e.g., streamed, downloaded, etc.). In some embodiments, the content monitoring circuitry 208 may utilize processor 202, memory 204, and/or communications hardware 206 to retrieve, at least in part, any media content detected from a user device. For example, the content monitoring circuitry 208 may utilize communications hardware 206 to download a copy of a transcript (e.g., subtitle data, etc.) for a video and/or download a copy of a text article from a media content server. In other examples, the content monitoring circuitry 208 may utilize communications hardware 206 to stream the media content to the apparatus 200 in order to generate a transcript for the media content (e.g., using natural language circuitry 212 and/or any transcript generation techniques described herein).

In some embodiments, the content monitoring circuitry 208 may utilize processor 202, memory 204, and/or communications hardware 206 to retrieve, at least in part, any user profile information (e.g., a user's risk profile, contact information, user survey data, user device identifiers, bank account data, investment portfolio data, real estate holding addresses, etc.) from storage device 110 and/or any financial disclosure documents or data (e.g., asset class, risk ratings, historical performance, fees, financial prospectuses, etc.) from financial institution server 112. For example, the content monitoring circuitry 208 may utilize processor 202, memory 204, and/or natural language circuitry 212 to identify (e.g., using a natural language processor, speech recognition algorithm, and/or LLM) keywords in the media content and retrieve a list of financial assets associated with a user's portfolio stored on storage device 110 (e.g., utilizing the communications hardware 206).

In addition, the apparatus 200 further comprises simulation circuitry 210 that generates quantitative predictions and/or the like as described herein. In some embodiments, the simulation circuitry 210 may be any means such as a device or circuitry embodied in either hardware (e.g., application specific interface circuit (ASIC) and/or the like as described herein) or a combination of hardware and software (e.g., algorithms and/or the like as described herein) that is configured to receive a transcript for media content and/or financial disclosure documents for an investment (e.g., from the communications hardware 206, the content monitoring circuitry 208, and/or storage device 110), process text documents (e.g., using natural language circuitry 212), assign the one or more keywords a weighted value (e.g., one or more of a scalar, probability, vector, etc.), generate a prediction model (e.g., neural network, etc.), train the prediction model (e.g., based on historical data, etc.), generate prediction model outputs (e.g., quantitative predictions, etc.), and/or the like as described below. The simulation circuitry 210 may utilize processor 202, memory 204, and/or any other hardware component included in the apparatus 200 to perform these operations which are described in greater detail below in connection with FIGS. 4 and 5D-5F. The simulation circuitry 210 may further utilize communications hardware 206 to gather data from a variety of sources (e.g., storage device 110, financial institution server 112, user devices 106A-106N, and/or media content servers 108A-108N as shown in FIG. 1), and/or exchange data with a user.

In some embodiments, the simulation circuitry 210 may obtain a transcript for media content, historical data, and/or a financial disclosure document (e.g., stored on storage device 110 by the content monitoring circuitry 208) and utilize the natural language circuitry 212 to parse (or segment) the transcript, historical data, and/or a financial disclosure document into one or more keywords. The one or more keywords may each be assigned a weighted value such as one or more of a scalar, probability, vector, and/or the like as described herein, based on the relationship of the words within the context of the transcript (of the media content). For example, the natural language circuitry 212 may comprise one or more artificial neural networks for vectorizing words (e.g., using Word2vec, GloVe, and/or other word embedding or vectorization techniques) as will be described in further detail below in connection with the natural language circuitry 212. The simulation circuitry 210 may compare the weighted values and/or keywords between each of the transcripts, historical data, and/or financial disclosure documents and determine how these keywords (and/or documents) relate to each other. For example, when a news article is determined to share a plurality of key words with a financial disclosure document (or directly references the investment described in the financial disclosure document), the simulation circuitry 210 may determine that the events of the news article may have a high probability of impacting the future performance of the investment or asset of the financial disclosure document. Accordingly, the simulation circuitry 210 may map the keywords of the news article (or other media content) to keywords in the financial disclosure document, such as keywords used to describe past and/or future key performance indicators (e.g., operating margin, growth, revenue, debt, environmental impact, etc.).

In some embodiments, the financial disclosure document (or keywords therein) may be used to search for historical data (e.g., past news articles, previous financial disclosure documents, etc.) to determine how the current news article may affect a future disclosure document and, thus, the future performance of an associated investment or asset. For example, when a financial disclosure document references the performance over a past time interval (e.g., a previous financial quarter, year, etc.) the simulation circuitry 210 may leverage the content monitoring circuitry 208 (or other hardware described herein) to retrieve historical data (e.g., media content for the past time interval). The media content for the past time interval may be parsed for keywords, assigned weighted values (e.g., vectorized, etc.), and/or mapped to keywords of the financial disclosure document to identify (e.g., using pattern recognition algorithms and/or any other AI systems described herein) one or more of patterns, correlations, and/or causations between the historical data and the performance described in the financial disclosure document. The simulation circuitry 210 may use any identifiable patterns, probabilities of correlations (e.g., correlation coefficients), and/or probabilities of causations between the historical data and the performance described in the financial disclosure document to generate, train, and/or retrain prediction models (e.g., artificial neural networks, etc.) for simulating (or predicting) future asset or investment performance. In some embodiments, the simulation circuitry 210 may store (e.g., to storage device 110, memory 204, etc.) keywords, weighted values, identified patterns, probabilities of correlations (e.g., correlation coefficients), probabilities of causations, and/or any other quantitative performance data as described herein as input variables and/or output variables for prediction models. For example, vectors representative of keywords from media content may be stored as input variables for a prediction model. Vectors representative of keywords from historical data may be stored as training input variables for a prediction model and associated vectors representative of keywords from financial disclosure documents may be stored as training output variables for the prediction model. The simulation circuitry 210 may use a prediction model to generate one or more prediction model outputs comprising quantitative predictions for the future performance of an identified investment or asset based on the indicated media content (and/or the like as described above).

In addition, the apparatus 200 further comprises natural language circuitry 212 that generates qualitative predictions and/or the like as described herein. In some embodiments, the natural language circuitry 212 may be any means such as a device or circuitry embodied in either hardware (e.g., application specific interface circuit (ASIC) and/or the like as described herein) or a combination of hardware and software (e.g., algorithms and/or the like as described herein) that is configured to parse or segment text documents into keywords (e.g., for use by the simulation circuitry 210 as described herein), vectorize keywords (e.g., for use by the simulation circuitry 210 and/or for use with one or more natural language techniques as described herein), generate, train, and/or retrain a natural language model (e.g., LLM, artificial neural network, etc.), generate a natural language report (e.g., representative of an interpretation of quantitative prediction and/or the like as described herein), and/or the like as described below. The natural language circuitry 212 may utilize processor 202, memory 204, and/or any other hardware component included in the apparatus 200 to perform these operations which are described in greater detail below in connection with FIGS. 4 and 5G. The natural language circuitry 212 may further utilize communications hardware 206 to gather data from a variety of sources (e.g., storage device 110, financial institution server 112, user devices 106A-106N, and/or media content servers 108A-108N as shown in FIG. 1), and/or exchange data with a user (e.g., receive user prompts, and/or provide written and/or spoken natural language reports via one or more user devices).

In some embodiments, the natural language circuitry 212 may determine if two or more pieces of media content (e.g., media content of interest indicated by a user, historical media content or other data, etc.) are similar by using keyword clustering, K-Means clustering with text documents, word embedding or vectorization techniques (e.g., Word2vec, GloVe, etc.), and/or any other semantic meaning or context grouping techniques. In some such embodiments, the natural language circuitry 212 may comprise one or more of an artificial neural network, LLM, natural language processing (NLP) pipeline, and/or the like for vectorizing words and/or generating natural language reports. For example, the natural language circuitry 212 may comprise a multi-layer (e.g., two-layer or another number) artificial neural network for leveraging Word2vec techniques (e.g., Continuous Bag of Words (CBOW) and/or skip-gram techniques), and/or other NLP techniques described herein, to obtain vector representations of words (e.g., keywords, etc.). It will be understood that word vectors represent information about the meaning of a word based on surrounding words (e.g., in a sentence, paragraph, document, and/or based on synonymous words, etc.). In some embodiments, word vectors may be any multi-dimensional numerical representation of a word mapped to nearby vectors in space.

In some embodiments, words with similar (or related) meaning are mapped to similar word vectors (e.g., similarity of vectors may be measured by cosine similarity, Euclidean distance, or other data analysis techniques for measuring semantic similarity). For example, keywords such as “stock,” and “mutual fund” may share similar meaning (e.g., both are tradeable assets and a mutual fund may include stocks) and would have word vectors with similar numerical values. For example, “stock” may be represented, in a particular dataset or corpus of keywords (e.g., compiled from media content, historical data, user profile information, etc.), with a first word vector of {0.6, 0.9,0.1, 0.9, −0.7, −0.3, −0.2} and “mutual fund” may be represented with a second word vector of {0.5, 0.8, −0.1, 0.8, −0.6, −0.5, −0.1}. Further, in such embodiments, the word embedding element may be associated with, or representative of, a particular meaning, category, and/or word type. For example, the first and second word vectors for “stock” and “mutual fund” respectively may represent how closely they relate to one or more particular meanings, categories, and/or word types, in particular each vector element may be mapped to word embedding of {investment, asset, bond, trade, debt, verb, plural}. It will be understood that the closer to 1.0 a vector element is the closer the word represented by the word vector is to the word embedding element. For example, “stock” and “mutual fund” are both assets so they have a 0.9 and 0.8 in the “asset” element respectively. In some embodiments, more or less dimensions (or elements) may be utilized to represent a vector or vector space. In some embodiments, the natural language circuitry 212 may train and/or retrain an LLM and/or the multi-layer (e.g., two-layer or another number) artificial neural network for leveraging Word2vec techniques (and/or other NLP techniques described herein) using a corpus of text taken from one or more of the Internet, user profile information (e.g., user surveys, risk assessments, financial advisor correspondence, etc.), media content servers (e.g., any of media content server 108A-108N), financial institution server 112 (e.g., financial disclosure documents, etc.), and/or any other data source as described herein.

The natural language circuitry 212 may utilize processor 202, memory 204, and/or any other hardware component included in the apparatus 200 to parse, segment, and/or tokenize words in media content (e.g., articles, transcripts, etc.) and/or any other documentation as described herein. In some embodiments, the natural language circuitry 212 may comprise a parsing algorithm, word tokenization algorithm, word slicer algorithm, and/or the like to generate word tokens from one or more documents (e.g., media content, historical data, user profile information, etc.). Further, the natural language circuitry 212 may map each tokenized word to word vectors (as described herein) and the semantic similarity between words may correspond to a geometric distance in the vector space (as described above). Further, word vectors may be learned by an LLM, artificial neural network, and/or the like based on the context in which words appear (e.g., in a corpus of text, respective documents, etc.). In some embodiments, the same or similar words may have different word vectors, meaning, and/or emphasis based on the particular media content and/or any other documentation used to train and/or retrain the LLM, artificial neural network, and/or the like. The natural language circuitry 212 may retrieve one or more word vectors for each word (or select keywords) in the media content and/or any other documentation using a Word2vec (or GloVe) model and/or the like as described herein. In some embodiments, the natural language circuitry 212 may combine two or more word vectors (e.g., by averaging some or all word vectors of a document) to create a representation of the embedding for the particular media content and/or any other documentation. In some such embodiments, the natural language circuitry 212 may compare the representations of the embedding for two or more pieces of particular media content and/or any other documentation and determine a similarity score (e.g., using cosine similarity, Euclidean distance similarity, and/or the like) between the two or more pieces of particular media content and/or any other documentation. For example, when media content (e.g., a news article, etc.) of interest to a user is determined to have a high similarity score with historical data (e.g., a historical report, etc.), the natural language circuitry 212 may transmit the historical data (and/or associated word vectors) to the simulation circuitry 210 for use in generating one or more quantitative predictions and/or training (or retraining) a prediction model and/or algorithm.

Additionally or alternatively, the natural language circuitry 212 may utilize the historical data (e.g., associated word vectors, context, tone, etc.) to generate one or more qualitative predictions and/or train (or retrain) an LLM, artificial neural network, and/or the like as described herein. It will be understood that similarity scores using cosine similarity measures the cosine of the angle between two vectors (e.g., word vectors, averaged word vectors of a document, and/or the like as described herein). Further, a cosine of the angle equal, or close, to 1.00 indicates a high similarity between words (or documents) and a cosine of the angle equal or close to 0.00 indicates low similarity between words (or documents). In some embodiments, a similarity threshold may be used to determine when two vectors are sufficiently similar. For example, a similarity threshold may be equal to 0.75 (or any other number) and a cosine of the angle equal to, or greater than, the similarity threshold may cause the natural language circuitry 212 to determine that the two vectors (e.g., representative of two words or documents) are at least sufficiently similar for further operations as described herein (e.g., training or retraining a model, making a quantitative and/or qualitative prediction, etc.). In such embodiments, a cosine of the angle less than the similarity threshold may cause the natural language circuitry 212 to determine that the two vectors (e.g., representative of two words or documents) are not sufficiently similar. In some embodiments, the natural language circuitry 212 may store each tokenized word, word vector, and/or similarity score to one or more databases (e.g., in storage device 110 and/or the like).

In some embodiments, the natural language circuitry 212 may use aggregated global word-to-word co-occurrence statistics from a given corpus of text to train and/or retrain an unsupervised learning algorithm or model. For example, by examining how often words appear together within a corpus of text (e.g., a document, set of documents, etc.) a GloVe model or algorithm (or the like as described herein) may determine, learn, or identify relationships between words, hidden patterns, similarities, and/or differences which may be represented by word vectors and/or word clusters. In some embodiments, clustering algorithms may be utilized to group data points (e.g., representative of word clusters and/or documents) based on exclusive clustering, k-means clustering, overlapping clustering, fuzzy k-means clustering, hierarchical clustering, and/or any other clustering techniques as described herein. In some embodiments, the natural language circuitry 212 may utilize principal component analysis (PCA) techniques to reduce the number of dimensions by keeping only the significant principal components, such as, those with larger eigenvalues, eigenvectors, and/or the like (e.g., based on a threshold value). It will be understood that processing data (e.g., keyword data, word vector data, tokenized word data, and/or any other data as described herein) with PCA techniques advantageously saves computing storage space, reduces the burden on processing resources, and/or reduces the burden on memory resources, etc.).

In addition, the apparatus 200 further comprises device registration circuitry 214 that may verify one or more credentials associated with a user and/or a user device (e.g., any of user devices 106A-106N) based on stored credentials (e.g., in a user profile stored on storage device 110) associated with an authentic and/or authorized user (e.g., of the predictive advisement system 102) and/or user device (e.g., of a PIoT of the user). The device registration circuitry 214 may utilize processor 202, memory 204, or any other hardware component included in the apparatus 200 to perform these operations, as described in connection with FIGS. 4 and 5A below. The device registration circuitry 214 may further utilize communications hardware 206 to gather data from, and/or exchange data with, a variety of sources (e.g., user devices 106A-106N, storage device 110, financial institution server 112, and/or media content servers 108A-108N, as shown in FIG. 1). The device registration circuitry 214 may verify one or more credentials and/or complete one or more handshake protocols associated with the variety of sources (e.g., to establish a secured and/or encrypted communication channel via communications network 104, login and/or register a user, etc.). The device registration circuitry 214 may further utilize communications hardware 206 to exchange data with a user, such as to setup a user profile, register an account, connect a user device of a PIoT with the predictive advisement system 102, install a software plugin, provide a natural language report with sensitive data, and/or any other operations as described herein. In some such embodiments, the device registration circuitry 214 may utilize processor 202 and/or memory 204 to verify a user and/or a user device with a user profile or account before allowing use of the predictive advisement system 102. In some embodiments, the device registration circuitry 214 may prevent, at least in part, sensitive data (e.g., Personally Identifiable Information (PII), encrypted and/or sensitive data, etc.) associated with a user and/or financial institution (e.g., bank, financial advisor, etc.) from being transmitted to one or more of the variety of sources. In some embodiments, the device registration circuitry 214 may handle any or all security verification (e.g., handshake protocols, check security certificate validity, and/or the like) associated with transmitting and/or receiving data via the communications network 104.

In some embodiments, the device registration circuitry 214 may store user profile information (e.g., login, name, home address, passwords, bank account numbers, investment account numbers, user settings and/or preferences, risk assessments, user surveys, financial goals, real estate holding addresses, etc.) to storage device 110 (e.g., in a secured and/or encrypted database). In some embodiments, the device registration circuitry 214 may store user device information (e.g., IP address, Medium Access Control (MAC) address, device name, serial number, user interface capabilities, port numbers, etc.) to storage device 110 (e.g., in a secured and/or encrypted database). In some such embodiments, the predictive advisement system 102 may utilize user device information to identify which devices to monitor for media content (or the like) and/or to identify which devices may receive a natural language report and/or other data. Further, the predictive advisement system 102 may utilize user device information to determine how to present (or render) a natural language report and/or any other data described herein. For example, a user device with a speaker (e.g., a home assistant device) may receive an audio based natural language report and a device with a screen or display (e.g., digital photo frame) may receive a text based natural language report. A user device with multiple user interface capabilities (e.g., a speaker and a display), such as a smart television, mobile device, etc., may receive a natural language report in one or more formats (e.g., audio, text, video, etc.) based on a user setting or preference.

Although components 202-214 are described in part using functional language, it will be understood that the particular implementations necessarily include the use of particular hardware. It should also be understood that certain of these components 202-214 may include similar or common hardware. For example, the content monitoring circuitry 208, simulation circuitry 210, natural language circuitry 212, and device registration circuitry 214 may each at times leverage use of the processor 202, memory 204, and/or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “circuitry” with respect to elements of the apparatus therefore shall be interpreted as necessarily including the particular hardware configured to perform the functions associated with the particular element being described. Of course, while the term “circuitry” should be understood broadly to include hardware, in some embodiments, the term “circuitry” may in addition refer to software instructions that configure the hardware components of the apparatus 200 to perform the various functions described herein.

Although the content monitoring circuitry 208, simulation circuitry 210, natural language circuitry 212, and device registration circuitry 214 may leverage the processor 202, memory 204, or communications hardware 206 as described above, it will be understood that any of the content monitoring circuitry 208, simulation circuitry 210, natural language circuitry 212, and device registration circuitry 214 may include one or more dedicated processors, specially configured field programmable gate array (FPGA), or application specific interface circuit (ASIC) to perform its corresponding functions, and may accordingly leverage the processor 202 for executing software stored in a memory (e.g., memory 204), or communications hardware 206 for enabling any functions not performed by special-purpose hardware. In all embodiments, however, it will be understood that the content monitoring circuitry 208, simulation circuitry 210, natural language circuitry 212, and device registration circuitry 214 comprise particular machinery designed for performing the functions described herein in connection with such elements of apparatus 200.

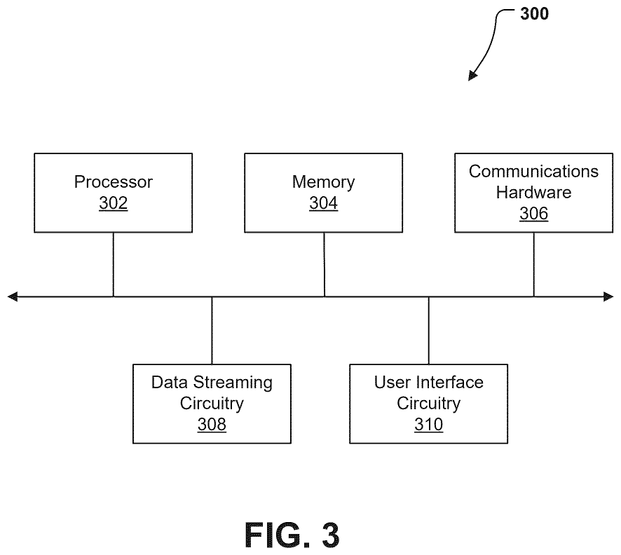

Turning to FIG. 3, as illustrated, an apparatus 300 is shown that represents an example user device (e.g., any of user devices 106A-106N, a user device of a PIoT, a user device of a financial advisor, etc.) or an example media content server (e.g., any of media content servers 108A-108N). The apparatus 300 includes processor 302, memory 304, and communications hardware 306, each of which is configured to be similar to the similarly named components described above in connection with FIG. 2.

The apparatus 300 may also include data streaming circuitry 308, which includes hardware components designed for streaming and/or accessing audio and/or video media content via the communications network 104 (e.g., the Internet) to one or more computing devices (e.g., any of user devices 106A-106N, apparatus 200, etc.). The data streaming circuitry 308 may utilize processor 302, memory 304, or any other hardware component included in the apparatus 300 to perform these operations, as described herein. The data streaming circuitry 308 may further utilize communications hardware 306 to communicate with one or more computing devices, establish a communications channel via the communications network 104, and stream data from the apparatus 300 (or a storage device, associated with apparatus 300, hosting media content) via the established communications channel.

The data streaming circuitry 308 may utilize processor 302, memory 304, or any other hardware component included in the apparatus 300 to retrieve (or receive) a portion of media content (e.g., a subtitle track, a transcript, an audio track of a video, etc.) and/or stream (or transmit) the portion of media content (e.g., to one or more computing devices). For example, the predictive advisement system 102 may identify media content (e.g., a video, etc.) and may request only a portion of the media content in order to reduce the burden on computing and/or network resources. It will be understood that streaming (or transmitting) a subtitle track, a transcript, an audio track of a video, etc., requires less computing resources and network resources than streaming (or transmitting) the entirety of a video. In addition, streaming (or transmitting) a subtitle track or a transcript of an audio data object (e.g., audio file, podcast, etc.) requires less computing resources and network resources than streaming (or transmitting) the entirety of an audio data object. In some embodiments, the data streaming circuitry 308 may identify and provide streaming instructions to one or more media content servers associated with a particular media content system (e.g., a particular news organization, etc.) that are not co-located at the same location but that may each stream similar or the same media content.

The data streaming circuitry 308 may utilize processor 302, memory 304, or any other hardware component included in the apparatus 300 to generate executable software instructions to instruct one or more media content servers (e.g., any of media content servers 108A-108N) to stream (or transmit) media content or the like. For example, when data streaming circuitry 308 receives a plurality of requests to access or stream media content, the data streaming circuitry 308 may assign each request to a respective media content server. In some embodiments, the data streaming circuitry 308 may stream (or transmit) live media content (e.g., a live news broadcast, a live show, etc.) and/or stored media content (e.g., a prerecorded broadcast, show, documentary, etc.). In some embodiments, the data streaming circuitry 308 may include a hardware based encoder (or decoder) to convert and/or encode (or decode) a data stream (e.g., a data stream between analog and digital signals). It will be understood that use of a hardware based encoder (or decoder) may be advantageous over conventional software based encoders (or decoders) to reduce the burden on processing and memory resources (e.g., of apparatus 300), that may be traditionally leveraged by conventional software based encoders (or decoders).

In addition, the apparatus 300 may also include user interface circuitry 310, which includes hardware components designed for receiving user inputs, rendering (or displaying) virtual graphic outputs, and/or producing audio or sound outputs. The user interface circuitry 310 may utilize processor 302, memory 304, or any other hardware component included in the apparatus 300 to perform these operations, as described herein. The user interface circuitry 310 may further utilize communications hardware 306 to transmit data representative of a user input and/or receive data to render as a virtual graphics output. The user interface circuitry 310 may utilize processor 302 and/or memory 304 to generate data representative of a user input and/or generate virtual graphic outputs and/or sound, e.g., based on received data. The user interface circuitry 310 may comprise one or more of a keyboard, pointing device, touchscreen, microphone with speech recognition interface, camera with gesture-based interface, or other input device capable of receiving various different user inputs. In addition, the user interface circuitry 310 may comprise a display device including one or more of a screen with graphical user interface (GUI), speaker, light emitting diode (LED), haptic technology device, or any other output device capable of rendering information to a user as described herein.

In some embodiments, various components of the apparatus 200 and apparatus 300 may be hosted remotely (e.g., by one or more cloud servers) and thus need not physically reside on the corresponding apparatus (e.g., apparatus 200, apparatus 300, or the like). For instance, some components of the apparatus 200 may not be physically proximate to the other components of apparatus 200. Similarly, some or all of the functionality described herein may be provided by third party circuitry. For example, a given apparatus 200, or 300, may access one or more third party circuitries in place of local circuitries for performing certain functions.

As will be appreciated based on this disclosure, example embodiments contemplated herein may be implemented by an apparatus 200, an apparatus 300, and/or a combination thereof. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some embodiments of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses (e.g., apparatus 200 and apparatus 300), example embodiments are described below in connection with a series of flowcharts.

### Example Operations

Turning to FIGS. 4 and 5A-5G, example flowcharts are illustrated that contain example operations implemented by example embodiments described herein. The operations illustrated in FIGS. 4 and 5A-5G may, for example, be performed by a system device (e.g., server, etc.) of the predictive advisement system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, content monitoring circuitry 208, simulation circuitry 210, natural language circuitry 212, device registration circuitry 214, and/or any combination thereof.

It will be understood that user interaction with the predictive advisement system 102 may occur directly via communications hardware 206, or may instead be facilitated by a separate user device (e.g., any of user devices 106A-106N shown in FIG. 1, which may in turn be embodied by an apparatus 300, which is shown and described in connection with FIG. 3), as shown in FIG. 1, and which may have similar or equivalent physical componentry facilitating such user interaction. It will be understood that media content server (e.g., any of media content servers 108A-108N) and/or financial institution server 112 interaction with the predictive advisement system 102 may occur directly via communications hardware 206, or may instead be facilitated by a separate server (e.g., embodied by an apparatus 300, which is shown and described in connection with FIG. 3), as shown in FIG. 1, and which may have similar or equivalent physical componentry facilitating such server interaction.

Turning to FIG. 4, example operations are shown for simulating future asset performance based on consumable media content.

As shown by operation 402, the apparatus 200 may include means, such as processor 202, memory 204, communications hardware 206, content monitoring circuitry 208, or the like, for monitoring a user device for receipt of a data stream comprising media content. For example, the content monitoring circuitry 208 may receive one or more data objects (e.g., data packets, etc.) from a user device installed with a companion software plugin of the predictive advisement system 102. The one or more data objects may indicate media content received at the user device (e.g., via a video streaming application, a web browser application, a banking or financial investment application, etc.). Operation 402 is described in further detail below in connection with FIG. 5A.

As shown by operation 404, the apparatus 200 may include means, such as processor 202, memory 204, communications hardware 206, simulation circuitry 210, or the like, for receiving a simulation request requesting a prediction model for an asset of a user portfolio based on the media content. For example, a user via a user device (e.g., installed with a companion software plugin of the predictive advisement system 102) may indicate (e.g., using user interface circuitry 310 or the like) media content of interest to the user and may request additional information for the indicated media content. In some examples, the simulation request may further indicate one or more assets of a user investment portfolio to be analyzed in relation to the media content. Operation 404 is described in further detail below in connection with FIGS. 5B-5C.

As shown by operation 406, the apparatus 200 may include means, such as processor 202, memory 204, communications hardware 206, simulation circuitry 210, natural language circuitry 212, or the like, for generating the prediction model for the asset of the user portfolio by feeding the asset of the user portfolio and the media content into one or more machine learning models. For example, the simulation circuitry 210 may generate an artificial neural network to simulate (or predict) the future performance of the asset indicated at operation 404 based on one or more correlation coefficients identified between the media content indicated at operation 404 and historical data (e.g. minded from the Internet, financial institution server 112, media content servers 108A-108N, etc.). In some embodiments, operation 406 may further include training the prediction model based on training data (e.g., training input and/or output variables) as described herein. In some embodiments, the prediction model may comprise a numerical or statistical prediction model or forecast model for one or more assets of one or more investment portfolios associated with a user. Operation 406 is described in further detail below in connection with FIGS. 5D-5E.

As shown by operation 408, the apparatus 200 may include means, such as processor 202, memory 204, communications hardware 206, simulation circuitry 210, natural language circuitry 212, or the like, for generating a prediction model output indicating future performance of the asset of the user portfolio based on the media content and historical data. For example, the natural language circuitry 212 may compile a plurality of keywords associated with word vectors from the indicated media content (or other data from the simulation request) and the simulation circuitry 210 may utilize the word vectors (and/or other data as described herein) as input variables for the prediction model (e.g., generated and/or trained at operation 406). Further, the prediction model may produce one or more prediction model outputs (e.g., numerical values, quantitative predictions, simulations, forecasts, and/or the like as described herein) for at least the indicated asset. Operation 408 is described in further detail below in connection with FIG. 5F.

As shown by operation 410, the apparatus 200 may include means, such as processor 202, memory 204, communications hardware 206, natural language circuitry 212, or the like, for generating a natural language report representative of the future performance of the asset of the user portfolio. For example, the natural language circuitry 212 may feed the prediction model output (e.g., quantitative prediction, etc.) and any associated data (e.g., the indicated media content, the mined historical data, financial disclosure documents, etc.) into a natural language model (e.g., LLM or the like) to generate the natural language report (e.g., qualitative prediction, etc.). Further, the natural language circuitry 212 may provide a prompt for the natural language model to execute, such as a question and/or set of instructions (e.g., included in the simulation request at operation 404). The prompt may be in the form or a question, such as “Will the events described in this news article cause the indicated stock to increase or decrease in value over the next 12 months?” The prompt may be in the form of a set of instructions, such as “Simulate and describe a day-by-day stock chart for the indicated stock 30 days into the future.” In some embodiments, the natural language circuitry 212 may leverage GenAI (e.g., via webservices) to generate images, graphs, and/or charts to accompany a description provided in a natural language report. Operation 410 is described in further detail below in connection with FIG. 5G.

As shown by operation 412, the apparatus 200 may include means, such as processor 202, memory 204, communications hardware 206, natural language circuitry 212, or the like, for transmitting the natural language report to the user device. For example, once the natural language report is obtained at operation 410, the natural language circuitry 212 may format, encode, and/or secure (e.g., encrypt, etc.) the natural language report and the communications hardware 206 may transmit the natural language report to one or more user devices identified by a user account associated with a user. For example, a text copy of the natural language report may be emailed to a user's email address that is accessible via a mobile device and an audio file copy of the natural language report may be transmitted to a user's smart television and read aloud to the user. The natural language report may comprise one or more responses or answers to one or more user questions. The natural language report may further comprise a description or explanation of how the subject of a piece of media content will affect one or more of a financial goal, career goal, personal plans (e.g., vacations, etc.), investments or assets, and/or the like of the user.

In some embodiments, the natural language report may comprise an objective interpretation (e.g., based on numerical and/or statistical relationships of keywords) of the quantitative predictions provided by the prediction model (described above at operation 406). For example, the natural language report may simulate the language and/or tone of a financial expert interpreting a financial forecast (or the like), without including personal bias or subjective (e.g., anecdotal experience, etc.) information. The natural language report may further comprise a set of instructions for the user the follow in order to achieve (or increase the likelihood of achieving) a particular outcome. For example, the natural language report may include a listing of which stocks (or other investments) to purchase now to minimize financial loses or maximize financial gains in light of current events. Additionally or alternatively, the natural language report may further comprise information to respond to humanitarian events reported in media content. For example, the natural language report may include a listing of verifiable charitable organizations that are assisting with events described by the media content (e.g., forest fires, flooding, earthquakes, armed conflicts, etc.). In such embodiments, the natural language report may include a listing of items requested for donation (e.g., scraped or mined from a charitable organizations website and/or any other sources). In some embodiments, the natural language report may include qualitative predictions as described herein.

In some embodiments, the apparatus 200 may transmit one or more natural language reports to a user and/or financial advisor on a regular or periodic basis. For example, a user may receive a daily, weekly, etc., video presentation (e.g., AI generated video comprising the content of one or more natural language reports as described herein) or any other natural language report format described herein. The regular or periodic natural language report may comprise one or more natural language reports requested by the user over the previous time period (e.g., the last day, week, etc.). In some embodiments, the regular or periodic natural language report may comprise updates (e.g., automatically generated by the apparatus 200 or based on a request for periodic update from the user and/or the financial advisor of the user) for one or more previous natural language reports.

In some embodiments, the generation and/or transmission of the natural language report may occur in real-time, or near-real-time. As described herein, the natural language report may be customized (or tailored) for distribution to, and rendering on, one or more devices of a user's PIoT. For instance, a user may request that they receive any or all natural language reports to their smartphone. Further, the user may request that the natural language report be configured in a particular format or formats (as described herein). For example, the natural language report may comprise an audio report that is read aloud to the user via the smartphone speakers while a graphical user interface (GUI) displays (or highlights) portions of the user's financial portfolio (or the like) in relation to the portions of the audio report being read aloud. In some examples, the GUI displaying (or highlighting) the portions of the user's financial portfolio (or the like) may be on the user's smartphone (or any other device with a display) while the audio portion of the natural language report being read aloud may be rendered by another device (e.g., a home assistant, radio, television, or any other device with a speaker). In such examples, the two or more devices may be synchronized to provide a single natural language report experience for the user.

In other examples, the user may receive the natural language report on their smart television and the GUI may render a separate viewing pane from a news broadcast or news article highlighting the portions of the user's financial portfolio and/or corresponding portions from the media content. In some examples, the GUI may highlight portions of the media content (e.g., in a first view pane, etc.) and further display (e.g., via captions or popups, etc.) the impact that the highlighted portions of the media content will have on the user's financial portfolio, personal life (e.g., career, vacations, goals, etc.). In some examples, the GUI may highlight portions of the media content in a first view pane (or window) and may further display in one or more additional view panes (or windows) the impact that the highlighted portions of the media content will have on the user's financial portfolio, personal life (e.g., career, vacations, goals, etc.). In such examples, the two or more panes may automatically scroll through, and/or highlight portions of, the content of each pane (or window) while the natural language report is read aloud via a speaker. In some examples, the natural language report may be broken into constituent parts (e.g., audio objects, text reports, visual or video objects, etc.) and each constituent part may be displayed on a device of a PIoT.

In some embodiments, the operation 412 may include using a GenAI system to break up a natural language report into constituent parts and customize each constituent part for display on a particular user device (e.g., based on user preferences, the user's location, the user's proximity to one or more user devices, etc.). For example, the GenAI system may determine that a user is in their living room (e.g., based on their smartphone location, the television being on, home assistant speakers, etc.) and, in response the GenAI system may configured the natural language report (or the like) for display on one or more devices located in the user's living room.

In some embodiments, operation 402 may be performed in accordance with the operations described in FIG. 5A. Turning to FIG. 5A, example operations are shown for monitoring a user device for receipt of a data stream comprising media content (e.g., from one or more of media content servers 108A-108N).

As shown by operation 502, the apparatus 200 may include means, such as processor 202, memory 204, communications hardware 206, content monitoring circuitry 208, device registration circuitry 214, or the like, for registering one or more user devices, associated with a user, with a predictive advisement system. In some embodiments, the operation 502 may include registering a user account, associated with a user, with a predictive financial advisement system (e.g., via a webpage, software application, etc.). For example, a user may be prompted by a software plugin during installation to setup a user profile with the predictive financial advisement system. In some embodiments, the operation 502 may include linking a user profile with one or more of a bank account, investment portfolio, financial advisor profile (e.g., including a financial advisor email and/or other contact information), such as hosted at one or more financial institution servers (e.g., financial institution server 112). In some embodiments, the operation 502 may include linking the user profile to one or more user devices (e.g., of a PIoT of the user). In some such embodiments, the operation 502 may further include authenticating one or more user devices linked to the user profile (e.g., by displaying or reading out loud an authentication code to the user via the user interface circuitry 310 of the user device and having the user enter the authentication code into a webpage or software application).

As shown by operation 504, the apparatus 200 may include means, such as processor 202, memory 204, communications hardware 206, content monitoring circuitry 208, device registration circuitry 214, or the like, for transmitting executable software instructions for installing a software plugin associated with the predictive advisement system. In some embodiments, the operation 504 may include identifying one or more user devices (e.g., any of user devices 106A-106N, apparatus 300, etc.) linked to, or identified in, a user profile and transmitting executable software instructions for installing a software plugin (e.g., a companion application or the like) to each user device of the user profile. In some embodiments, the software plugin associated with the predictive advisement system 102 may comprise one or more of a web browser plugin, a smart television plugin, a companion application, and/or the like as described herein for monitoring a user device for media content and exchanging data with the predictive advisement system 102. In some embodiments, upon receipt of the executable software instructions, a user device (e.g., any of user devices 106A-106N, apparatus 300, etc.) may execute the executable software instructions and install the software plugin (or the like).

As shown by operation 506, the apparatus 200 may include means, such as processor 202, memory 204, communications hardware 206, content monitoring circuitry 208, device registration circuitry 214, or the like, for receiving one or more port identifiers representative of open ports of the user device. In some embodiments, the operation 506 may include scanning a user device, using the software plugin (or the like) installed at operation 504, to identify one or more ports of the user device that are utilized to receive data (e.g., media content, web browsing, data streaming, etc.). In some embodiments, a user may indicate, via the software plugin (or the like) (and the user interface circuitry 310 of the apparatus 300) media content of interest, such as a news article on a webpage, a broadcast on their smart television, or the like. In some such embodiments, the operation 506 may include receiving one or more media content identifiers representative of media content of interest to the user. An identifier (e.g., for media content, historical data, financial disclosure documents, etc.) may include, without limitation, a URL, deep link, application-specific link, and/or any other content specific routing information for locating media content via the communications network 104. In some embodiments, the software plugin (or the like) may monitor an operating system and/or one or more software applications of the user device to detect or identify media content. The software plugin (or the like) may be integrated into one or more software applications (e.g., web browsers, news application, video streaming applications, etc.) on the user device.

As shown by operation 508, the apparatus 200 may include means, such as processor 202, memory 204, communications hardware 206, content monitoring circuitry 208, or the like, for monitoring the open ports of the user device for network traffic indicative of the data stream comprising the media content. For example, as a user watches a documentary or news broadcast associated with a particular current event, the software plugin (or the like) may identify that the data stream comprises media content that may be of interest to the user. In addition, the software plugin (or the like) may record (or capture) a media content identifier associated with the documentary or news broadcast, such as an application-specific link (or the like) for a video streaming application. In some embodiments, the software plugin (or the like) may monitor the user interface circuitry 310 of the apparatus 300 for user inputs indicating media content of interest. For example, as a user browses the Internet for news articles related to a particular current event, the user (via the software plugin (or the like)) may identify one or more news articles of interest to the user. In addition, the software plugin (or the like) may record (or capture) a media content identifier associated with each news article, such as a URL. In some embodiments, open ports and/or media content (or media content identifiers) may be indicated to the software plugin (or the like) by one or more applications installed on the user device. In some embodiments, open ports may be associated with one or more applications installed on the user device. In some embodiments, the operation 508 may include listening, using the software plugin (or the like), to network traffic through one or more open ports locally at the user device and periodically transmitting (e.g., using the communications hardware 306) network traffic data to the content monitoring circuitry 208. In some embodiments, the software plugin (or the like) may monitor a communications network access point (e.g., router, etc.) of a PIoT.

In some embodiments, operation 404 may be performed in accordance with the operations described in FIG. 5B. Turning to FIG. 5B, example operations are shown for receiving a user initiated simulation request.

As shown by operation 510, the apparatus 200 may include means, such as processor 202, memory 204, communications hardware 206, simulation circuitry 210, or the like, for receiving a first user input indicative of a request for a correlation, or a causation, between the media content and the future performance of the asset of the user portfolio. For example, a user may indicate using the software plugin (or the like) and the user interface circuitry 310 of their user device (e.g., embodied as the apparatus 300) that they would like to receive a report (e.g., quantitative prediction, qualitative prediction, a natural language report, and/or the like as described herein) indicating how the current events described in a news article (or other media content) will affect the value of one or more assets of the user investment portfolio. In some embodiments, the operation 510 may include capturing (or recording), by a microphone and/or speech recognition software, a question and/or set of instructions (as described above) from the user to prompt the predictive advisement system 102 (e.g., the natural language circuitry 212, etc.). In such embodiments, the software plugin (or the like) may comprise speech recognition software or may leverage speech recognition software already installed on the apparatus 300. In some embodiments, the operation 510 may include selecting, using the software plugin (or the like) and the user interface circuitry 310, one or more assets (e.g., stocks, bonds, mutual funds, index funds, currencies, cryptocurrencies, etc.) held in the user investment portfolio. For example, a user may click on one or more assets displayed via a graphical user interface of the software plugin. In some embodiments, the first user input may identify a particular portion of the media content (e.g., a keyword, the subject of a particular paragraph, a time interval on a video or audio track, etc.).

As shown by operation 512, the apparatus 200 may include means, such as processor 202, memory 204, communications hardware 206, simulation circuitry 210, or the like, for receiving a second user input indicative of a request for a correlation, or a causation, between an executable transaction and the future performance of the user portfolio. For example, a user may indicate using the software plugin (or the like) and the user interface circuitry 310 of their user device (e.g., embodied as the apparatus 300) that they would like to receive a report (e.g., quantitative prediction, qualitative prediction, a natural language report, and/or the like as described herein) indicating how one or more actions (e.g., an executable transaction to buy, sell, and/or hold an asset) taken now will affect the value of one or more assets of the user investment portfolio in light of the current events described in a news article (or other media content). In some embodiments, the operation 512 may include capturing (or recording), by a microphone and/or speech recognition software, a question and/or set of instructions (as described above) from the user to prompt the predictive advisement system 102 (e.g., the natural language circuitry 212, etc.). In such embodiments, the software plugin (or the like) may comprise speech recognition software or may leverage speech recognition software already installed on the apparatus 300. In some embodiments, the operation 512 may include selecting, using the software plugin (or the like) and the user interface circuitry 310, one or more actions (e.g., an executable transaction to buy, sell, and/or hold an asset) for one or more assets held in the user investment portfolio. For example, a user may click on one or more assets displayed via a graphical user interface of the software plugin and select a respective action (e.g., to buy, sell, hold, etc.) for each asset. In some embodiments, the second user input may identify one or more assets not currently held in the user investment portfolio. For example, the user may search for additional assets via a web browser and use the software plugin to indicate one or more discovered assets (e.g., stocks, bonds, index funds, rental property addresses, currencies, precious metals, etc.). In some embodiments, the software plugin may suggest one or more assets based on media content keywords. In some embodiments, the second user input may request that the predictive advisement system 102 recommend or suggest assets, actions, and/or strategies based on the media content. In some embodiments, the second user input may request that the predictive advisement system 102 notify the user's financial advisor of the simulation request and request that the financial advisor analyze the simulation request (and corresponding predictions) and contact the user. In such embodiments, the predictive advisement system 102 may transmit, via communications network 104 to the financial advisor's user device, a text message, email, and/or push notification indicating the user's request. The contact information of the financial advisor may be stored in the user profile information of the user.

In some embodiments, operation 404 may be performed in accordance with the operations described in FIG. 5C. Turning to FIG. 5C, example operations are shown for receiving a system initiated simulation request.

As shown by operation 514, the apparatus 200 may include means, such as processor 202, memory 204, communications hardware 206, content monitoring circuitry 208, or the like, for determining that the user device meets or exceeds an interaction threshold associated with the media content. In some embodiments, the interaction threshold may comprise a number of interaction instances, such as a number of times a user interacted with a piece of media content via one or more user devices. For example, when a user clicks on a news article link 3 times (or any other number) the content monitoring circuitry 208 may determine that the media content may be of interest to the user. In some embodiments, the interaction threshold may comprise a length of interaction time, such as a number of minutes a user views a piece of media content. For example, when a user watches a video for at least 5 minutes (or any other number), or watches at least 50% (or any other number) of the video, the content monitoring circuitry 208 may determine that the media content may be of interest to the user. In some embodiments, other metrics (as described herein) may be compared to an interaction threshold to determine that the media content may be of interest to the user.

As shown by operation 516, the apparatus 200 may include means, such as processor 202, memory 204, communications hardware 206, content monitoring circuitry 208, or the like, for obtaining a transcript of the media content. In some embodiments, the operation 516 may include downloading a copy of a transcript (e.g., subtitle track or data, etc.) for a video or audio data object from a media content server (e.g., any of media content servers 106A-106N). In some embodiments, the operation 516 may include downloading (e.g., based on a media content identifier) a copy of a text article from a media content server (e.g., any of media content servers 106A-106N). In some embodiments, the operation 516 may include capturing (or copying), using the software plugin (or the like), the text of an article from a web browser. For example, while a user is viewing a news article the software plugin (installed with a web browser application on apparatus 300 or the like) may copy the text of the article and transmit a copy to the predictive advisement system 102 (e.g., embodied as apparatus 200). In some examples, the operation 516 may include streaming (e.g., based on a media content identifier) the media content from a media content server (e.g., any of media content servers 106A-106N) to the predictive advisement system 102 in order to generate a transcript for the media content (e.g., using natural language circuitry 212, a speech recognition algorithm, and/or any transcript generation techniques described herein).

As shown by operation 518, the apparatus 200 may include means, such as processor 202, memory 204, communications hardware 206, simulation circuitry 210, natural language circuitry 212, or the like, for parsing the transcript into a first plurality of keywords. For example, a parsing algorithm, word tokenization algorithm, word slicer algorithm, and/or the like may be utilized to recognize words within the transcript of the media content and generate word tokens. In some embodiments, the operation 518 may include storing the word tokens extracted from the transcript of the media content to a data table, database, or the like (e.g., within storage device 110, or the like). In some embodiments, the operation 518 may include storing each word token with additional information comprising one or more of an identifier (e.g., media content identifier, user identifier, historical data identifier, financial disclosure document identifier, etc.), a number of occurrences of the word, word-to-word co-occurrence statistics, and/or any other metrics as described herein. In some embodiments, the word token and the additional information may be stored as a key-value-pair within a key-value database (or data table) that utilizes the word token (or combination of word token and media content identifier) as the key and the additional information as the value(s) associated with the key. It will be understood that a respective database (or data table) may be generated for each unique iteration of operations 402-412. For example, when a combination of word token and identifier (indicating the respective source of the word token) are utilized a respective database (or data table) may be stored for each piece of media content (or any other documentation as described herein) and/or a shared database (or data table) may be generated that combines word tokens from a plurality of media content (and/or any other documentation as described herein). In some embodiments, operation 518 may further include identifying, from the first plurality of keywords, one or more keywords representative of one or more assets associated with the user profile information (e.g., held in an investment portfolio indicated in their profile information).

As shown by operation 520, the apparatus 200 may include means, such as processor 202, memory 204, communications hardware 206, simulation circuitry 210, or the like, for retrieving one or more asset disclosures associated with the user portfolio. In some embodiments, the operation 520 may include retrieving one or more financial disclosure documents (or any other asset related information described herein) from the user profile information (e.g., an investment portfolio of the user), the Internet, financial institution server 112, and/or any other source of financial information as described herein. For example, during operation 518, keywords (e.g., company name, ticker or stock symbol, real estate zip code or area code, etc.) related to one or more assets (e.g., stock, mutual fund, bond, real estate, Real Estate Investment Trust (REIT), etc.) may be identified based on user profile information and in response the financial disclosure documents associated with the one or more assets may be retrieve for further processing. For example, a news article may reference an increase in crime in a particular neighborhood, town, city, county, etc., where a user invests in real estate (e.g., rental properties, etc.) and in response public records (e.g., home price trends, police reports, tax records, etc.) may be retrieved for further analysis.

As shown by operation 522, the apparatus 200 may include means, such as processor 202, memory 204, communications hardware 206, simulation circuitry 210, natural language circuitry 212, or the like, for parsing the one or more asset disclosures into a second plurality of keywords. For example, a parsing algorithm, word tokenization algorithm, word slicer algorithm, and/or the like may be utilized to recognize words within the one or more asset disclosures (e.g., financial disclosure documents, police reports, tax records, and/or the like as described herein) and generate word tokens. In some embodiments, the operation 522 may include storing the word tokens extracted from the one or more asset disclosures to a data table, database, or the like (e.g., within storage device 110, or the like). In some embodiments, the operation 522 may include storing each word token with additional information comprising one or more of an identifier (e.g., media content identifier, user identifier, historical data identifier, financial disclosure document identifier, etc.), a number of occurrences of the word, word-to-word co-occurrence statistics (e.g., with other words in the same asset disclosure and/or the same word in one or more other documents, such as the transcript of the media content), and/or any other metrics as described herein. In some embodiments, the word token and the additional information may be stored as a key-value-pair within a key-value database (or data table) that utilizes the word token (or combination of word token and financial disclosure document identifier) as the key and the additional information as the value(s) associated with the key. It will be understood that a respective database (or data table) may be generated for each unique iteration of operations 402-412. For example, when a combination of word token and identifier (indicating the respective source of the word token) are utilized a respective database (or data table) may be stored for each asset disclosure (or any other documentation as described herein) and/or a shared database (or data table) may be generated that combines word tokens from a plurality of asset disclosures (and/or any other documentation as described herein).

As shown by operation 524, the apparatus 200 may include means, such as processor 202, memory 204, communications hardware 206, simulation circuitry 210, or the like, for comparing the first plurality of keywords and the second plurality of keywords. In some embodiments, the operation 524 may include matching identical keywords (or the same keyword) that appears in both the first plurality of keywords and the second plurality of keywords. In some embodiments, the operation 524 may include matching synonymous keywords (e.g., based on dictionary and/or thesaurus data) that appear in the first plurality of keywords and the second plurality of keywords. In some embodiments, the operation 524 may include updating each word token (e.g., stored at operation 518 and/or operation 522) with additional information indicating a number of matching identical keywords and/or word-to-word co-occurrence statistics (e.g., for any matching identical keywords and/or matching synonymous keywords). In some embodiments, the operation 524 may include updating one or more key-value-pairs and/or one or more key-value databases (or data tables) to reflect the number of matching identical keywords and/or word-to-word co-occurrence statistics for the same or similar keywords.

As shown by operation 526, the apparatus 200 may include means, such as processor 202, memory 204, communications hardware 206, simulation circuitry 210, or the like, for determining one or more of matching keywords or synonymous keywords. In some embodiments, the determination at operation 526 is based, at least in part, on the comparison at operation 524. In some embodiments, the operation 526 may include determining that there are no matching keywords or synonymous keywords between two or more documents (e.g., media content, asset disclosure, etc.). In some such embodiments, the apparatus 200 may perform one or more of operations 520-524 (e.g., until at least one pair of matching keywords and/or synonymous keywords are identified).

As shown by operation 528, the apparatus 200 may include means, such as processor 202, memory 204, communications hardware 206, simulation circuitry 210, natural language circuitry 212, or the like, for generating the simulation request based on the one or more of matching keywords or synonymous keywords. For example, the apparatus 200 may utilize the transcript of the media content, any identified assets (and/or asset disclosures), historical data (e.g., past user simulation requests, prompts, questions, etc.), and/or any matching keywords and/or synonymous keywords to generate a prompt (e.g., question, command, etc.) and internally generate a system initiated simulation request. For example, the prompt may be a question about the identified media content (e.g., a news article on increasing property taxes for single family homes in a particular town) and the identified asset (e.g., a single family rental property in the particular town) using one or more matching keywords and/or synonymous keywords (e.g., “single family homes” and “single family rental property”). For example, the apparatus 200 may generate a question (e.g., “How will an increase in property taxes impact the rent for my single family rental property?”) and utilize that internally generated question to generate a system initiated simulation request. In some embodiments, the operation 528 may include transmitting the system initiated simulation request to a user device (e.g., embodied as apparatus 300) in order to obtain a response for whether the user wants to utilize the system initiated simulation request (or any associated question(s)). In some embodiments, the operation 528 may include receiving, from the apparatus 300, a user response indicating an acceptance or a denial of the system initiated simulation request. When the user response indicates an acceptance of the system initiated simulation request, the operation 528 may continue to operation 406. When the user response indicates a denial of the system initiated simulation request, the operation 528 may continue to operation 402. It will be understood that the system initiated simulation request (or any other simulation request described herein) may comprise a prompt (e.g., question, command, set of instructions, etc.) and one or more identifiers (e.g., media content identifier and/or any other identifiers as described herein).

In some embodiments, operation 406 may be performed in accordance with the operations described in FIGS. 5D-5E. Turning to FIG. 5D, example operations are shown for generating and/or training a prediction model.

As shown by operation 530, the apparatus 200 may include means, such as processor 202, memory 204, communications hardware 206, content monitoring circuitry 208, or the like, for accessing the media content from a media server. In some embodiments, the apparatus 200 may request or identify the media content and/or media content server based on a media content identifier. In some embodiments, the operation 530 may include establishing, via communications network 104, a communications channel (e.g., secured communications channel, a virtual private network (VPN) connection, an end-to-end encryption channel, etc.) with a media content server (e.g., any of media content servers 108A-108N) and/or a financial institution server 112 (e.g., hosting financial articles or user specific financial data). In some embodiments, the operation 530 may include monitoring the communications channel for transmission errors, corrupted data, malicious data, unauthenticated and/or unauthorized access attempts, and/or the like. In some embodiments, the operation 530 may include transmitting and/or receiving one or more data objects (e.g., media content, transcripts, user information, etc.) via the communications channel. For example, the apparatus 200 may transmit a request to stream or download a piece of media content and, in response, the apparatus 200 may receive the requested piece of media content (e.g., from apparatus 300 via the communications network 104).

As shown by operation 532, the apparatus 200 may include means, such as processor 202, memory 204, communications hardware 206, content monitoring circuitry 208, or the like, for obtaining a transcript of the media content. In some embodiments, the operation 532 may include downloading a copy of a transcript (e.g., subtitle track or data, etc.) for a video or audio data object from a media content server (e.g., any of media content servers 106A-106N). In some embodiments, the operation 532 may include downloading (e.g., based on a media content identifier) a copy of a text article from a media content server (e.g., any of media content servers 106A-106N). In some embodiments, the operation 532 may include capturing (or copying), using the software plugin (or the like), the text of an article from a web browser. For example, while a user is viewing a news article the software plugin (installed with a web browser application on apparatus 300 or the like) may copy the text of the article and transmit a copy to the predictive advisement system 102 (e.g., embodied as apparatus 200). In some examples, the operation 532 may include streaming (e.g., based on a media content identifier) the media content from a media content server (e.g., any of media content servers 106A-106N) to the predictive advisement system 102 in order to generate a transcript for the media content (e.g., using natural language circuitry 212, a speech recognition algorithm, and/or any transcript generation techniques described herein). In some embodiments, the operation 532 may include retrieving a transcript or a subtitle track of the media content. In some embodiments, the operation 532 may include retrieving an audio track of the media content and processing the audio track with a language model comprising a speech recognition algorithm to generate the transcript.

As shown by operation 534, the apparatus 200 may include means, such as processor 202, memory 204, communications hardware 206, simulation circuitry 210, natural language circuitry 212, or the like, for parsing the transcript into a plurality of keywords. For example, a parsing algorithm, word tokenization algorithm, word slicer algorithm, and/or the like may be utilized to recognize words within the transcript of the media content and generate word tokens. In some embodiments, the operation 534 may include storing the word tokens extracted from the transcript of the media content to a data table, database, and/or the like. In some embodiments, the operation 534 may include one or more operations and/or features as described above in connection with operation 518 and/or operation 522.

As shown by operation 536, the apparatus 200 may include means, such as processor 202, memory 204, communications hardware 206, simulation circuitry 210, natural language circuitry 212, or the like, for assigning a weighted value to each keyword of the plurality of keywords. In some embodiments, the one or more keywords may each be assigned a weighted value such as one or more of a scalar, probability, vector, and/or the like as described herein, based on the relationship of the words within the context of the transcript (of the media content). For example, the apparatus 200 may assign each keyword a word vector as described above in connection with the natural language circuitry 212.

As shown by operation 538, the apparatus 200 may include means, such as processor 202, memory 204, communications hardware 206, simulation circuitry 210, natural language circuitry 212, or the like, for comparing the weighted value of each keyword to a keyword value threshold. A keyword value threshold may include a set (or minimum) number of occurrences, word-to-word co-occurrence statistics, and/or any other metrics as described herein. In some embodiments, keywords with a higher (or greater) number of occurrences, word-to-word co-occurrence statistics, and/or any other metrics as described herein, may be given more weight (e.g., assigned a higher scalar) than words with a lower (or lesser) number of occurrences, word-to-word co-occurrence statistics, and/or any other metrics as described herein. For example, a keyword that does not meet a keyword value threshold for number of occurrences, word-to-word co-occurrence statistics, and/or any other metrics as described herein may be disregarded from further analysis and/or deleted from a data table (or database) (e.g., to save storage or memory space and reduce the processing power required to process a set of data). It will be understood that some keywords mentioned, for example, in media content may be mentioned only in passing, or as analogues examples, and may not be pertinent to the main subject of the media content (or simulation request). Further, the apparatus 200 may filter or delete these keywords from further analysis to ensure that only more pertinent information (e.g., historical data, user information, assets, etc.) is retrieved and analyzed at generate the prediction model.

As shown by operation 540, the apparatus 200 may include means, such as processor 202, memory 204, communications hardware 206, simulation circuitry 210, natural language circuitry 212, or the like, for identifying a subset of keywords of the plurality of keywords. For example, the identified subset of keywords may be one or more keywords that met or exceeded the keyword value threshold at operation 538 as described above.

As shown by operation 542, the apparatus 200 may include means, such as processor 202, memory 204, communications hardware 206, content monitoring circuitry 208, or the like, for retrieving the historical data from a database associated with the subset of keywords. In some embodiments, the historical data may be identified based on a similarity score between one or more keywords parsed from the historical data and the subset of keywords identified at operation 540. In some embodiments, the apparatus 200 may request or identify the historical data, server, and/or database based on a historical data identifier. In some embodiments, the operation 542 may include establishing, via communications network 104, a communications channel (e.g., secured communications channel, a virtual private network (VPN) connection, an end-to-end encryption channel, etc.) with a media content server (e.g., any of media content servers 108A-108N), a financial institution server 112, storage device 110, and/or any other computing device for hosting historical data as described herein. In some embodiments, the operation 542 may include monitoring the communications channel for transmission errors, corrupted data, malicious data, unauthenticated and/or unauthorized access attempts, and/or the like. In some embodiments, the operation 542 may include transmitting and/or receiving one or more data objects (e.g., historical data, transcripts, user information, etc.) via the communications channel. For example, the apparatus 200 may transmit a request to stream or download historical data and, in response, the apparatus 200 may receive the requested historical data (e.g., from apparatus 300, or the like, via the communications network 104).

As shown by operation 544, the apparatus 200 may include means, such as processor 202, memory 204, communications hardware 206, simulation circuitry 210, natural language circuitry 212, or the like, for mapping the weighted value for one or more keywords of the subset of keywords to the historical data. For example, matching or synonymous keywords parsed from the historical data may be mapped with (or assigned) the same weighted values (e.g., word vectors, etc.) assigned to a respective matching or synonymous keyword of the subset of keywords. It will be understood that by mapping (or assigning) the matching or synonymous keywords of the historical data with a respective weighted value (e.g., word vectors, etc.) of the subset of keywords, the subset of keywords may be linked (e.g., via a correlation coefficient, probability, etc.) to one or more of the outcome keywords discussed below in connection with operation 548. Further, the current events discussed by the media content may be linked (e.g., via a correlation coefficient, probability, etc.) to the historical outcomes of similar past events. In some embodiments, the operation 544 may include processing the historical data in accordance with one or more of operations 522-526 as described above for processing the one or more asset disclosures.

Turning to FIG. 5E, example operations are shown for generating and/or training a prediction model.

As shown by operation 546, the apparatus 200 may include means, such as processor 202, memory 204, communications hardware 206, simulation circuitry 210, natural language circuitry 212, or the like, for storing each respective weighted value of the one or more keywords of the subset of keywords as training input variables. In some embodiments, the operation 546 may include storing each word token (e.g., to a database or data table as described herein) with additional information representative of at least a respective weighted value and/or a training input variable marker (e.g., a data tag, marker, value, or any other indication that the word token and/or additional information may be utilized as training data for training an AI system). In some embodiments, the operation 546 may include accessing and/or updating one or more word tokens and/or databases described above in connection with operation 404.

As shown by operation 548, the apparatus 200 may include means, such as processor 202, memory 204, communications hardware 206, simulation circuitry 210, natural language circuitry 212, or the like, for identifying one or more outcome keywords in the historical data that indicate a correlation with, or a causation from, the one or more keywords mapped to the historical data. For example, the operation 548 may include processing the historical data in accordance with one or more of operations 522-526 as described above for processing the one or more asset disclosures in order to identify one or more outcome keywords. An outcome keyword may be one or more keywords indicating a result for an action or event described in the historical data. For example, a historical news article may discuss that a drought, during a previous year, caused the price of irrigation equipment stock to increase over the following months. In such an example, the keywords “drought” and “irrigation equipment stock” may be matching or synonymous keywords from the subset of keywords describe above at operation 544 and the outcome keywords identified in the historical news article (i.e., the historical data) may be “price,” “increase,” and/or “over the following months.” In some embodiments, the operation 548 may include storing the one or more outcome keywords to a databased (or data table) as described herein.

As shown by operation 550, the apparatus 200 may include means, such as processor 202, memory 204, communications hardware 206, simulation circuitry 210, natural language circuitry 212, or the like, for assigning a weighted value to each of the one or more outcome keywords. In some embodiments, the operation 550 may include calculating a correlation coefficient, probability, likelihood score, and/or the like as described herein, relating the one or more keywords of the subset of keywords (e.g., stored as training input variables) to the one or more outcome keywords of the historical data. For example, the keyword “drought” may be determined to have a high correlation (e.g., may be assigned a high correlation coefficient or the like) with the resulting “price” “increase” of the “irrigation equipment stock” given in the example described above at operation 548. In some embodiments, calculating one or more of a correlation coefficient, probability, likelihood score, and/or the like as described herein, between a keyword and an outcome keyword, may be performed using word vector and semantic representations and/or one or more statistical analysis techniques (e.g., Pearson correlation coefficient, cosine similarity, Euclidean distance, probability equations, and/or any other statistical analysis techniques).

As shown by operation 552, the apparatus 200 may include means, such as processor 202, memory 204, communications hardware 206, simulation circuitry 210, natural language circuitry 212, or the like, for storing each respective weighted value of the one or more outcome keywords as training output variables. In some embodiments, the operation 552 may include generating and/or storing one or more word tokens each representative of a respective outcome keyword to a database (or data table) as described herein for storing word tokens with additional information. In some embodiments, the operation 552 may include storing each word token (e.g., to a database or data table as described herein) with additional information representative of at least a respective weighted value and/or a training output variable marker (e.g., a data tag, marker, value, or any other indication that the word token and/or additional information may be utilized as training data for training an AI system). For example, each word token representative of a respective outcome keyword may be stored with additional information indicating the correlation coefficient, probability, likelihood score, and/or the like as described above in connection with operation 550.

As shown by operation 554, the apparatus 200 may include means, such as processor 202, memory 204, communications hardware 206, simulation circuitry 210, natural language circuitry 212, or the like, for training the prediction model based on the training input variables and the training output variables. In some embodiments, the operation 554 may include inputting (or feeding) the training input variables into an input layer of a prediction model comprising an artificial neural network. In some such embodiments, the input layer may comprise an input node for each of the training input variables (e.g., as described above in connection with operation 546). In some embodiments, the operation 554 may include adjusting (or updating) one or more hidden layers of the artificial neural network to link the input layer to an output layer of the neural network. In some such embodiments, the output layer may comprise an output node for each of the training output variables (e.g., as described above in connection with operation 552). In some embodiments, the operation 554 may include receiving, based on the training input variables, predicted output variables from the neural network. In some embodiments, the one or more hidden layers of the artificial neural network may link the input layer to an output layer using one or more equations or weighted values as described herein. For example, the one or more hidden layers of the artificial neural network may link the input layer to an output layer based on one or more correlation coefficients, statistical equations, and/or the like as described above. Further, the predicted output variables, generated by the artificial neural network based on the training input variables, may be compared to the known training output variables to determine how accurately the prediction model predicted the known training output variables. In some embodiments, the operation 554 may include comparing the predicted output variables to the known training output variables to determine (or calculate) an error value or difference between the predicted and known output variables. In some embodiments, the operation 554 may include updating one or more weighted values and/or equations of the one or more hidden layers to reduce one or more errors between the predicted output variables and the training output variables. In some embodiments, updating the one or more weighted values and/or equations of the one or more hidden layers may be based on the determined (or calculated) error value or difference between the predicted and known output variables. For example, the one or more hidden layers may be updated to reduce the error value or difference between the predicted and known output variables. In some embodiments, the operation 554 may performed iteratively until the error value or difference between the predicted and known output variables is reduced to 0 or satisfies an error threshold (e.g., a predefined number or percentage, error converges to a limit, a confidence interval, etc.) and/or the number of iterations meets or exceed an iteration threshold.

In some embodiments, operation 408 may be performed in accordance with the operations described in FIG. 5F. Turning to FIG. 5F, example operations are shown for generating a prediction model output and/or a quantitative prediction.

As shown by operation 556, the apparatus 200 may include means, such as processor 202, memory 204, communications hardware 206, simulation circuitry 210, natural language circuitry 212, or the like, for determining a plurality of keywords from a transcript of the media content. In some embodiments, the operation 556 may include retrieving (e.g., from storage device 110) one or more keywords stored in a database (or data table) as described above. In some embodiments, the operation 556 may include performing one or more of operation 530-534 as described above for one or more identified pieces of media content. In some embodiments, the operation 556 may include identifying additional media content different from that indicated in the simulation request. For example, the apparatus 200 may search for similar media content (e.g., with similar publication dates, keywords, context, subjects, etc.) based on keywords identified in the media content indicated in the simulation request.

As shown by operation 558, the apparatus 200 may include means, such as processor 202, memory 204, communications hardware 206, simulation circuitry 210, natural language circuitry 212, or the like, for assigning a weighted value to each keyword of the plurality of keywords. In some embodiments, the one or more keywords may each be assigned a weighted value such as one or more of a scalar, probability, vector, and/or the like as described herein, based on the relationship of the words within the context of the transcript (of the media content). For example, the apparatus 200 may assign each keyword a word vector as described above in connection with the natural language circuitry 212.

As shown by operation 560, the apparatus 200 may include means, such as processor 202, memory 204, communications hardware 206, simulation circuitry 210, natural language circuitry 212, or the like, for storing each respective weighted value of each keyword of the plurality of keywords as prediction input variables. In some embodiments, the operation 560 may include storing each word token (e.g., to a database or data table as described herein) with additional information representative of at least a respective weighted value and/or a prediction input variable marker (e.g., a data tag, marker, value, or any other indication that the word token and/or additional information may be utilized for fulfilling a simulation request and/or generating a prediction model output or the like). In some embodiments, the operation 560 may include accessing and/or updating one or more word tokens and/or databases described above in connection with operations 404 and 556-558.

As shown by operation 562, the apparatus 200 may include means, such as processor 202, memory 204, communications hardware 206, simulation circuitry 210, natural language circuitry 212, or the like, for inputting the prediction input variables into an input layer of a neural network. In some embodiments, the operation 562 may include inputting (or feeding) the prediction input variables into an input layer of a prediction model comprising an artificial neural network. In some embodiments, the prediction model comprising the artificial neural network may be trained using training data, such as described above at operation 554 and/or the like as described herein. In some embodiments, the input layer may comprise an input node for each of the prediction input variables.

As shown by operation 564, the apparatus 200 may include means, such as processor 202, memory 204, communications hardware 206, simulation circuitry 210, natural language circuitry 212, or the like, for receiving the prediction model output comprising one or more of a weighted value and an outcome keyword. In some embodiments, the operation 564 may include receiving a quantitative prediction (or quantitative prediction data) comprising one or more of a weighted value (e.g., correlation coefficient, probability, likelihood score, and/or the like) and an outcome keyword. For example, the prediction model may receive keywords from the media content on interest to the user and in response the prediction model may output outcome keywords that are most like to result from the prediction input variables. For example, the prediction model may output one or more outcome keywords (or prediction output variables) each represented by a respective word vector and a probability or likelihood of occurrence based on the prediction input variables fed into the prediction model. In some embodiments, the operation 564 may include storing each word token representative of each outcome keyword (e.g., to a database or data table as described herein) with additional information representative of at least a respective weighted value and/or a prediction output variable marker (e.g., a data tag, marker, value, or any other indication that the word token and/or additional information may be utilized for fulfilling a simulation request and/or generating a natural language report or the like). In some embodiments, the operation 564 may include accessing and/or updating one or more word tokens and/or databases described above.

In some embodiments, operation 410 may be performed in accordance with the operations described in FIG. 5G. Turning to FIG. 5G, example operations are shown for generating a natural language report and/or a qualitative prediction.

As shown by operation 566, the apparatus 200 may include means, such as processor 202, memory 204, communications hardware 206, natural language circuitry 212, or the like, for training a natural language model with one or more historical text documents from the historical data. In some embodiments, the natural language model may comprise one or more of an LLM, an artificial neural network, recurrent neural network, supervised model, unsupervised model, and/or any other probabilistic model of a natural language. The natural language model may be a different model and/or AI system from the prediction model described above. In some embodiments, the operation 566 may include accessing and/or initializing a base language model (e.g., a base LLM or the like that has not been fined-tuned for a particular simulation request) and compiling a training data set comprising one or more historical text documents (e.g., historical news articles, transcripts of historical videos, etc.) and one or more word tokens from the training input variables and the known training output variables. It will be understood that the training input variables and the known training output variables may be labeled or annotated training data and the one or more historical text documents may be a training corpus of text. In some embodiments, the operation 566 may include inputting (or feeding) the training data set into the base language model to fine-tune the base language model (i.e., generate a fine-tuned language model for responding to a particular simulation request). The base language model may be fine-tuned for each respective simulation request to provide a personalized response (e.g., a personalized natural language report for each simulation request and/or prompt received from a user).

In some embodiments, the operation 566 may include storing (e.g., to storage device 110 or the like) the training data set and any corresponding simulation requests. The stored training data may be utilized to retrain the base language model in response to similar simulation requests or to provide updates as new or additional media content becomes available (e.g., at a future time). In some embodiments, the operation 566 may include preprocessing the one or more historical text documents (e.g., tokenizing the text, handling/removing special characters, and/or the like) before using the one or more historical text documents to train, retrain, or fine-tune the base language model. In some embodiments, the one or more word tokens associated with the training input variables and the known training output variables may be indicated (e.g., labeled, highlighted, tagged, marked, etc.) in the one or more historical text documents to indicate the word tokens associated with the particular causes and effects (e.g., inputs and outcomes). In some such embodiments, the one or more historical text documents may be formatted to include the indicated word tokens as input features for training. For example, the word tokens may include labels or other additional information (as described above) indicating which cause (e.g., input variable, keyword, and/or work token) is connected (or linked) to which effect (e.g., output variable, outcome keyword, and/or work token). Further, the labels may indicate the probability, correlation coefficient, or the like as described herein indicating the likelihood that a particular cause will produce a particular effect. In some embodiments, the natural language model may be trained in two stages. The first stage (or pre-training stage) may be an unsupervised learning stage comprising inputting the one or more historical text documents (e.g., the training corpus of text) into the base language model to train the base model on the general semantics, structures, and content of the language used for the one or more historical text documents. The second stage (or fine-tuning stage) may be a supervised learning stage comprising inputting the labeled word tokens (described above) into the base language model. During the second stage the base language model may be trained to recognize patterns within the one or more historical text documents that may be indicative of whether certain causes are associated with certain effects (or outcomes) without having to rely on specific cause and effect (or input and output) mapping.

As shown by operation 568, the apparatus 200 may include means, such as processor 202, memory 204, communications hardware 206, simulation circuitry 210, natural language circuitry 212, or the like, for inputting the prediction model output from the prediction model and a text document representative of the media content into the natural language model. In some embodiments, the operation 568 may include inputting (or feeding) the prediction input variables, prediction output variables (e.g., one or more outcome keywords generated by the prediction model), and the media content of interest to the user (e.g., a transcript of the media content) into the fined-tuned natural language model. In some embodiments, additional information may be input in to the fined-tuned natural language model, such as any user profile information, similar media content identified at operation 556, and/or any other data or information as described herein.

As shown by operation 570, the apparatus 200 may include means, such as processor 202, memory 204, communications hardware 206, simulation circuitry 210, natural language circuitry 212, or the like, for inputting the simulation request as a prompt for the natural language model. In some embodiments, the operation 570 may include extracting, from the simulation request, one or more questions, commands, and/or instructions to generate a prompt for the natural language model. For example, the question “How will an increase in property taxes impact the rent for my single family rental property?” may be extracted from the system initiated simulation request as described above. In some embodiments, one or more prompts may be selected from a database of predefined or general prompts. For example, a general prompt may be used such as “Describe the effect that the events of the media content will have on the identified asset.” In some embodiments, a prompt may include a plurality of questions, commands, and/or instructions. For example, a prompt may be a question followed by a command, such as “How will this flood impact my irrigation equipment stock? Provide a list of verified charities that I can donate to for flood relief.”

As shown by operation 572, the apparatus 200 may include means, such as processor 202, memory 204, communications hardware 206, simulation circuitry 210, natural language circuitry 212, or the like, for receiving a natural language output indicating the future performance of the asset of the user portfolio from the natural language model. In some embodiments, the operation 572 may include generating a natural language output using the fine-tuned natural language model based on the data input into the fine-tuned natural language model at operations 566-570 as described above. The natural language output may comprise a body of text describing the prediction model output (or quantitative predictions) from the prediction model and/or answering any questions (or fulfilling any commands, etc.) provided in the prompt. In some embodiments, the natural language output may comprise additional qualitative predictions that may be inferred from the quantitative predictions and/or the training data utilized at operation 566 as described above. For example, the fine-tuned natural language model may recognize patterns (e.g., hidden semantic structure, etc.) within media content and/or similar media content based on the one or more historical text documents that are not apparent or detectable using the quantitative techniques employed by the prediction model. In some embodiments, natural language output may be stored as a text file or data object (e.g., to storage device 110). The natural language output may comprise one or more features of the natural language report as described herein.

As shown by operation 574, the apparatus 200 may include means, such as processor 202, memory 204, communications hardware 206, simulation circuitry 210, natural language circuitry 212, or the like, for generating the natural language report by converting the natural language output into one or more of a text, audio, or video data object. In some embodiments, the operation 574 may include identifying, based on user profile information, one or more user devices for receipt of the natural language report. A user setting or preference may indicate which user device(s) (e.g., of a PIoT) should receive the natural language report and in which format the natural language report is to be provided. For example, a user may select to receive their reports as audio files that can be played on their phone, smart radio, and/or smart television. In such examples, the apparatus 200 may utilize a text to speech converter (or algorithm) to convert the natural language output (e.g., stored as a text file or data object) to spoken audio (e.g., an audio file or data object, Advanced Audio Coding (AAC) file, MP3 file, etc.). In some embodiments, the apparatus 200 may utilize a text to speech converter (or algorithm) and/or a GenAI system to convert the natural language output (e.g., stored as a text file or data object) to a video (e.g., a video file or data object, Audio Video Interleave (AVI) file, MP4 file, etc.). In some embodiments, the apparatus 200 may save the natural language output (e.g., stored as a text file or data object) to another text file format that may be compatible with one or more user devices (e.g., Word Document (DOC/DOCX), etc.). In some embodiments, user profile information may indicate that a user's financial advisor should receive a copy of the natural language report. In such embodiments, the apparatus 200 may format a copy of the natural language report for transmission to the financial advisor associated with the user profile information. The operation 574 may proceed to operation 412 as described above.

FIGS. 4 and 5A-5G illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware, circuitry, etc.) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Conclusion

As described above, example embodiments provide methods and apparatuses that enable improved simulation and prediction modeling of future asset performance based on consumable media content. Example embodiments thus provide tools that overcome the problems faced by traditional analytics systems and/or techniques for analyzing current events and/or other market factors to produce traditional prediction models. By avoiding the need for users to manually perform evaluations of quantitative data, example embodiments can save time and reduce the burden on computing resources, while also eliminating the possibility of human error due to subjective biases and perceptions that has been unavoidable with traditional analytics systems. In doing so, example implementations unlock the ability to provide benefits that were historically impossible results, such as the presentation of analysis relevant to a user based on a particular piece of consumable media content (e.g., a specific news story). Further, by providing improved systems and methods using both quantitative prediction models and qualitative natural language models, example embodiments reduce the risk associated with subjectively interpreting quantitative data by providing objective and systematic interpretations (e.g., by AI systems) to provide clear recommendations and/or instructions for users to act upon (e.g., by buying/selling stocks, holding more cash, etc.). Furthermore, embodiments described herein provide additional layers of customization (e.g., linking banking account, investment portfolio, and other information described herein) to enable more tailored (or personalized) predictions for a user.

As these examples all illustrate, example embodiments contemplated herein provide technical solutions that solve real-world problems faced during financial forecasting and personal investment portfolio modeling. And while individual investors and financial advisors have struggled with updating individual financial forecasts and personal investment portfolio models in light of daily, weekly, monthly, etc., shifting political landscapes and financial markets for years, the recently exploding amount of data made available by recently emerging AI technologies of today has made this problem significantly more acute, as the expectations of individual investors for reacting quickly to new information has grown, traditional systems have failed to keep up with these expectations. At the same time, the recently arising ubiquity of mobile devices, smart home technologies (e.g. PIoT, etc.), and secured digital communication has unlocked new avenues for solving these problems that have not historically been available, and example embodiments described herein thus represent a technical solution to these real-world problems associated with financial forecasting and personal investment portfolio modeling.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for simulating future asset performance based on consumable media content, the method comprising:
monitoring, by content monitoring circuitry, a user device for receipt of a data stream comprising media content;
receiving, by communications hardware, a simulation request requesting a prediction model for an asset of a user portfolio based on the media content;
generating, by simulation circuitry and using the prediction model, a prediction model output indicating future performance of the asset of the user portfolio based on the media content and historical data;
generating, by natural language circuitry and based on the prediction model output, a natural language report representative of the future performance of the asset of the user portfolio; and
transmitting, by the communications hardware, the natural language report to the user device.

2. The method of claim 1, wherein monitoring the user device for receipt of the data stream comprising media content further comprises:
registering, by device registration circuitry, one or more user devices associated with a user with a predictive advisement system, wherein the user device is one of the one or more user devices;
transmitting, by the communications hardware to at least the user device of the one or more user devices, executable software instructions for installing a software plugin associated with the predictive advisement system;
receiving, by the communications hardware, one or more port identifiers representative of open ports of the user device, wherein the open ports are associated with one or more media applications installed on the user device; and
monitoring, by the content monitoring circuitry, the open ports of the user device for network traffic indicative of the data stream comprising the media content, wherein the software plugin listens to the open ports locally at the user device and periodically transmit network traffic data to the content monitoring circuitry.

3. The method of claim 1, wherein receiving the simulation request requesting the prediction model for the asset of the user portfolio based on the media content further comprises:
receiving, by the communications hardware, a first user input via a software plugin of a predictive advisement system, wherein the first user input indicates a request for a correlation, or a causation, between the media content and the future performance of the asset of the user portfolio; and
receiving, by the communications hardware, a second user input via the software plugin, wherein the second user input indicates a request for a correlation, or a causation, between an executable transaction and the future performance of the user portfolio.

4. The method of claim 1, wherein receiving the simulation request requesting the prediction model for the asset of the user portfolio based on the media content further comprises:
determining, by the content monitoring circuitry, that the user device meets or exceeds an interaction threshold associated with the media content, wherein the interaction threshold comprises one or more of a number of interaction instances or a length of interaction time;
obtaining, by the communications hardware, a transcript of the media content;
parsing, by the simulation circuitry, the transcript into a first plurality of keywords;
retrieving, by the simulation circuitry, one or more asset disclosures associated with the user portfolio;
parsing, by the simulation circuitry, the one or more asset disclosures into a second plurality of keywords;
comparing, by the simulation circuitry, the first plurality of keywords and the second plurality of keywords;
determining, by the simulation circuitry, one or more of matching keywords or synonymous keywords; and
generating, by the simulation circuitry, the simulation request based on the one or more of matching keywords or synonymous keywords.

5. The method of claim 1, further comprising:
generating, by the simulation circuitry, the prediction model for the asset of the user portfolio by feeding the asset of the user portfolio and the media content into one or more machine learning models.

6. The method of claim 5, wherein generating the prediction model further comprises:
accessing, by the communications hardware, the media content from a media server;
obtaining a transcript of the media content;
parsing, by the simulation circuitry, the transcript into a plurality of keywords; and
assigning, by the simulation circuitry, a weighted value to each keyword of the plurality of keywords.

7. The method of claim 6, wherein obtaining the transcript further comprises:
retrieving, by the communications hardware, a transcript or a subtitle track of the media content; or
retrieving, by the communications hardware, an audio track of the media content, and processing, by the simulation circuitry, the audio track with a language model comprising a speech recognition algorithm to generate the transcript.

8. The method of claim 6, wherein generating the prediction model further comprises:
comparing, by the simulation circuitry, the weighted value of each keyword to a keyword value threshold;
identifying, by the simulation circuitry, a subset of keywords of the plurality of keywords, wherein the weighted value of each keyword of the subset of keywords is equal to or greater than the keyword value threshold;
retrieving, by the communications hardware, the historical data from a database associated with the subset of keywords;
mapping, by the simulation circuitry, the weighted value for one or more keywords of the subset of keywords to the historical data;
storing, by the simulation circuitry, each respective weighted value of the one or more keywords of the subset of keywords as training input variables;
identifying, by the simulation circuitry, one or more outcome keywords in the historical data that indicate a correlation with, or a causation from, the one or more keywords mapped to the historical data;
assigning, by the simulation circuitry, a weighted value to each of the one or more outcome keywords;
storing, by the simulation circuitry, each respective weighted value of the one or more outcome keywords as training output variables; and
training, by the simulation circuitry, the prediction model based on the training input variables and the training output variables.

9. The method of claim 8, wherein training the prediction model further comprises:
inputting, by the simulation circuitry, the training input variables into an input layer of a neural network, wherein the prediction model comprises the neural network;
adjusting, by the simulation circuitry, one or more hidden layers of the neural network to link the input layer to an output layer of the neural network, wherein the output layer comprises an output node for each of the training output variables;
receiving, by the simulation circuitry and based on the training input variables, predicted output variables from the neural network; and
updating, by the simulation circuitry, one or more values or equations of the one or more hidden layers to reduce one or more errors between the predicted output variables and the training output variables.

10. The method of claim 1, wherein generating the prediction model output for the asset of the user portfolio further comprises:
determining, by the simulation circuitry, a plurality of keywords from a transcript of the media content;
assigning, by the simulation circuitry, a weighted value to each keyword of the plurality of keywords;
storing, by the simulation circuitry, each respective weighted value of each keyword of the plurality of keywords as prediction input variables;
inputting, by the simulation circuitry, the prediction input variables into an input layer of a neural network, wherein the prediction model comprises the neural network; and
receiving, by the simulation circuitry and from the neural network, the prediction model output comprising one or more of a weighted value and an outcome keyword.

11. The method of claim 1, wherein generating the natural language report indicating the future performance of the asset of the user portfolio further comprises:
training, by the natural language circuitry, a natural language model with one or more historical text documents from the historical data;
inputting, by the natural language circuitry, the prediction model output from the prediction model and a text document representative of the media content into the natural language model;
inputting, by the natural language circuitry, the simulation request as a prompt for the natural language model;
receiving, by the natural language circuitry, a natural language output indicating the future performance of the asset of the user portfolio from the natural language model; and
generating, by the natural language circuitry, the natural language report by converting the natural language output into one or more of a text, audio, or video data object.

12. An apparatus for simulating future asset performance based on consumable media content, the apparatus comprising:
content monitoring circuitry configured to monitor a user device for receipt of a data stream comprising media content;
communications hardware configured to receive a simulation request requesting a prediction model for an asset of a user portfolio based on the media content;
simulation circuitry configured to generate, using the prediction model, a prediction model output indicating future performance of the asset of the user portfolio based on the media content and historical data;
natural language circuitry configured to generate, based on the prediction model output, a natural language report representative of the future performance of the asset of the user portfolio; and
transmit, by the communications hardware, the natural language report to the user device.

13. The apparatus of claim 12, further comprising:
device registration circuitry configured to register one or more user devices associated with a user with a predictive advisement system, wherein the user device is one of the one or more user devices,
wherein the communications hardware is further configured to:
transmit, to at least the user device of the one or more user devices, executable software instructions for installing a software plugin associated with the predictive advisement system, and
receive one or more port identifiers representative of open ports of the user device, wherein the open ports are associated with one or more media applications installed on the user device, and
wherein the content monitoring circuitry is further configured to monitor the open ports of the user device for network traffic indicative of the data stream comprising media content, wherein the software plugin listens to the open ports locally at the user device and periodically transmit network traffic data to the content monitoring circuitry.

14. The apparatus of claim 12, wherein the communications hardware is further configured to:
receive a first user input via a software plugin of a predictive advisement system, wherein the first user input indicates a request for a correlation or causation between the media content and future performance of the asset of the user portfolio; and
receive a second user input via the software plugin, wherein the second user input indicates a request for a correlation, or a causation, between an executable transaction and the future performance of the user portfolio.

15. The apparatus of claim 12, wherein the content monitoring circuitry is further configured to determine that the user device meets or exceeds an interaction threshold associated with the media content, wherein the interaction threshold comprises one or more of a number of interaction instances or a length of interaction time,
wherein the communications hardware is further configured to obtain a transcript of the media content, and
wherein the simulation circuitry is further configured to:
parse the transcript into a first plurality of keywords,
retrieve one or more asset disclosures associated with the user portfolio,
parse the one or more asset disclosures into a second plurality of keywords,
compare the first plurality of keywords and the second plurality of keywords,
determine one or more of matching keywords or synonymous keywords, and
generate the simulation request based on the one or more of matching keywords or synonymous keywords.

16. The apparatus of claim 15, wherein the simulation circuitry is further configured to generate the prediction model for the asset of the user portfolio by feeding the asset of the user portfolio and the media content into one or more machine learning models,
wherein the communications hardware is further configured to:
access the media content from a media server, and
obtain a transcript of the media content, wherein obtaining the transcript further comprises:
wherein the communications hardware is further configured to retrieve a transcript or a subtitle track of the media content, or
wherein the communications hardware is further configured to retrieve an audio track of the media content, and
wherein the simulation circuitry is further configured to process the audio track with a language model comprising a speech recognition algorithm to generate the transcript, and
wherein the simulation circuitry is further configured to:
parse the transcript into a plurality of keywords, and
assign a weighted value to each keyword of the plurality of keywords.

17. The apparatus of claim 16, wherein the simulation circuitry is further configured to:
compare the weighted value of each keyword to a keyword value threshold; and
identify a subset of keywords of the plurality of keywords, wherein the weighted value of each keyword of the subset of keywords is equal to or greater than the keyword value threshold,
wherein the communications hardware is further configured to retrieve the historical data from a database associated with the subset of keywords, and
wherein the simulation circuitry is further configured to:
map the weighted value for one or more keywords of the subset of keywords to the historical data,
store each respective weighted value of the one or more keywords of the subset of keywords as training input variables,
identify one or more outcome keywords in the historical data that indicate a correlation with, or a causation from, the one or more keywords mapped to the historical data,
assign a weighted value to each of the one or more outcome keywords,
store each respective weighted value of the one or more outcome keywords as training output variables, and
train the prediction model based on the training input variables and the training output variables.

18. The apparatus of claim 17, wherein the simulation circuitry is further configured to:
input the training input variables into an input layer of a neural network, wherein the prediction model comprises the neural network;
adjust one or more hidden layers of the neural network to link the input layer to an output layer of the neural network, wherein the output layer comprises an output node for each of the training output variables;
receive, based on the training input variables, predicted output variables from the neural network; and
update one or more values or equations of the one or more hidden layers to reduce one or more errors between the predicted output variables and the training output variables.

19. The apparatus of claim 12, wherein the simulation circuitry is further configured to:
determine a plurality of keywords from a transcript of the media content;
assign a weighted value to each keyword of the plurality of keywords;
store each respective weighted value of each keyword of the plurality of keywords as prediction input variables;
input the prediction input variables into an input layer of a neural network, wherein the prediction model comprises the neural network; and
receive, from the neural network, the prediction model output comprising one or more of a weighted value and an outcome keyword.

20. A computer program product for simulating future asset performance based on consumable media content, the computer program product comprising at least one non-transitory computer-readable storage medium storing software instructions that, when executed, cause an apparatus to:
monitor a user device for receipt of a data stream comprising media content;
receive a simulation request requesting a prediction model for an asset of a user portfolio based on the media content;
generate, using the prediction model, a prediction model output indicating future performance of the asset of the user portfolio based on the media content and historical data;
generate, based on the prediction model output, a natural language report representative of the future performance of the asset of the user portfolio; and
transmit the natural language report to the user device.
